(19) United States
(12) Patent Application Publication
(10) Pub. No.: US 2006/0253379 A1
(43) Pub. Date: Nov. 9, 2006

(54) Passive liquidity order

(75) Inventors: Paul D. Adcock, Burr Ride, IL (US); Michael A. Cormack, Evanston, IL (US); Thomas F. Haller, Longwood, IL (US); Robert A. Hill, LaGrang, IL (US)

Correspondence Address: LEFEVOUR LAW GROUP, LLC, 4365 LAWN AVE, SUITE 5, WESTERN SPRINGS, IL, 60558, US

(73) Assignee: Archipelago Holding, Inc.

(21) Appl. No.: 11/416,756

(22) Filed: May 3, 2006

Related U.S. Application Data
(60) Provisional application No. 60/678,634, filed on May 6, 2005.

(51) Int. Cl. G06Q 40/00

(52) U.S. Cl. 705/37

(57) ABSTRACT

A passive liquidity order and related market center and process are disclosed which allows market participants to trade without displaying any part of their order to the public order book, while still directly interacting with the public marketplace according to price/time priority rules that give preference to displayed trading interest over nondisplayed trading interest at the same price level. The passive liquidity order is a nondisplayed order type which allows participants to provide liquidity to the marketplace without publicly divulging their trading intentions.

### CROSS-REFERENCE TO RELATED APPLICATIONS

This application claims priority from and claims the benefit of U.S. Provisional Application No. 60/678,634, filed May 6, 2005, entitled “Passive Liquidity Order”, which is hereby incorporated by reference.

### BACKGROUND

Market centers want to provide the most liquidity they can because the more liquidity they can provide, the more traders they can attract. In present trading systems, Market Makers and Specialists are required to provide liquidity in the instruments in which they are appointed. Liquidity may also be provided on a voluntary basis by other market participants, including floor traders, institutional brokerages, investment firms, and hedge funds. The problem for a market center, however, is trying to entice market participants to post their orders to that specific market center to increase that market center's liquidity. Market participants have long argued that posting limit prices to a market center order book provides an advantage to those who take liquidity rather than to those who supply liquidity. These market participants argue that they trade at a disadvantage because other market participants see their displayed limit prices and manipulate the market by “pennying” and “front-running” for example.

Large institutions are especially sensitive about posting their orders to the market because when they do so, their trading intentions are publicly displayed to the marketplace and the display of such intentions, typically, has a very significant impact on the market. Large institutional investors often implement varying trading strategies in an effort to keep their intentions from being signaled to the market. An example of such a trading strategy is taking large orders and slicing them into smaller ones that, in theory, should have less impact on the market Another example is when large institutional investors negotiate deals off of the public market centers (i.e. trading off of the exchanges), reporting the trades only after they have been completed. The latter strategy hurts the public marketplace by removing potential liquidity from it.

Accordingly, there is a need for a limit-priced order which is available for matching in the public marketplace, but which is not displayed to the market. Such an order may provide the benefit of price improvement to incoming orders, which in turn, would encourage order flow. Furthermore, such an order would execute in a manner so as not to provide a disincentive for the posting of displayed limit-priced orders.

### SUMMARY

According to an aspect of the present invention, a method for providing liquidity to a market center includes providing a market center with displayed and partially displayed orders, and a mechanism for maintaining and ranking a nondisplayed passive liquidity order type on a posting market center, wherein the passive liquidity order has a specified but nondisplayed price and a specified but nondisplayed size. The posting market center then executes against incoming orders, according to a processing model wherein incoming orders match with displayed orders and reserve orders prior to matching with passive liquidity orders at the same price level.

### DESCRIPTION OF THE DRAWINGS

These and other features, aspects and advantages of the present invention will become better understood with regard to the following description, appended claims and accompanying drawings where:

FIG. 1 is a block diagram illustrating the trading environment in which an embodiment of the present invention operates;

FIG. 2 is a flow diagram illustrating a process implemented by an embodiment of the present invention for processing an incoming passive liquidity buy order;

FIG. 3 is a flow diagram illustrating a process implemented by an embodiment of the present invention to cancel or hold a passive liquidity order;

FIG. 4 is a flow diagram illustrating a process implemented by an embodiment of the present invention for possible passive liquidity buy order interaction with an incoming sell order that is not also a passive liquidity order;

FIG. 5 is a flow diagram illustrating a process implemented by an embodiment of the present invention to determine if a held passive liquidity buy order should be released;

FIG. 6 is a flow diagram illustrating a process implemented by an embodiment of the present invention for processing an incoming passive liquidity sell order;

FIG. 7 is a flow diagram illustrating a process implemented by an embodiment of the present invention for possible passive liquidity sell order interaction with an incoming buy order that is not also a passive liquidity order; and

FIG. 8 is a flow diagram illustrating a process implemented by an embodiment of the present invention to determine if a held passive liquidity sell order should be released.

### DETAILED DESCRIPTION

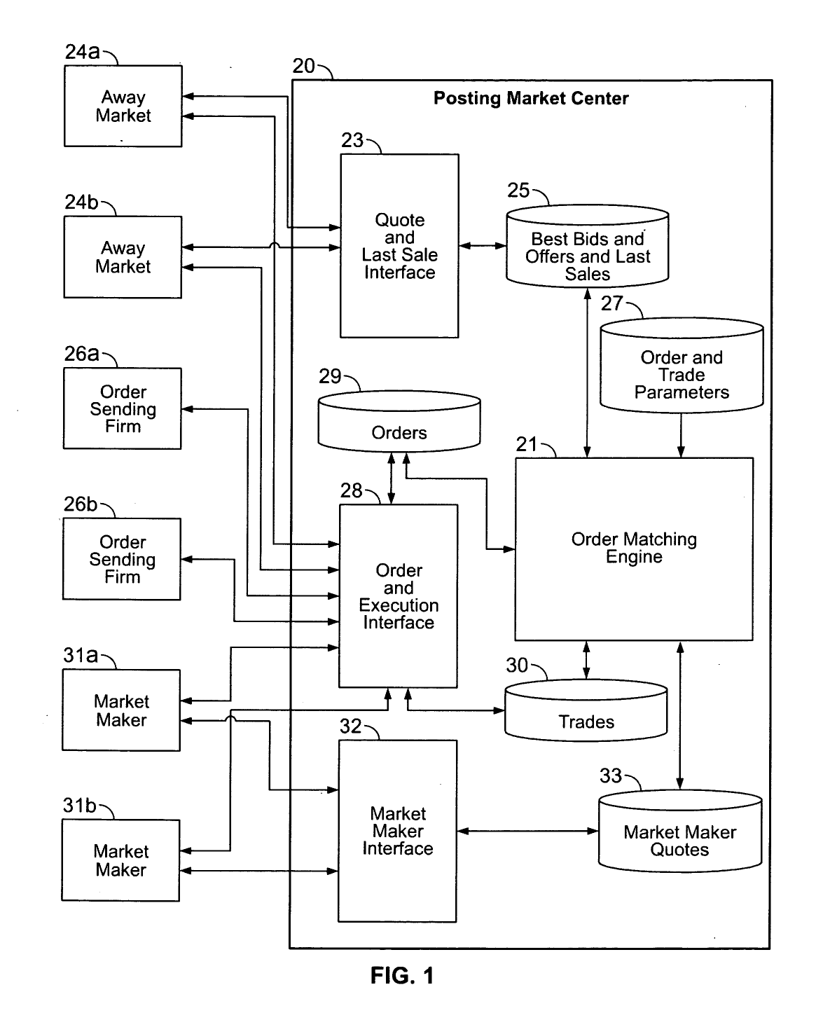

Referring to FIG. 1, a trading environment in which an embodiment of the system and method of the present invention operates is depicted. The examples discussed herein describe the use and application of the present invention in an equity security market center environment, but it should be understood that the present invention could be used in any type of financial instrument market center environment (e.g., equities, futures, options, bonds, etc.). The trading environment of this embodiment includes a posting market center 20 which interacts with a number of other market centers 24 (i.e. away markets), traders at order sending firms 26 and Market Makers 31. It should be understood that the trading environment of this embodiment supports but does not require Market Makers 31, a Market Maker Interface 32, or Market Maker Quotes 33. It should also be understood that the posting market center 20 referred to herein refers to a computing system having sufficient processing and memory capabilities and does not refer to a specific physical location. In fact, in certain embodiments, the computing system may be distributed over several physical locations. It should also be understood that any number of traders 26 or Market Makers 31 or away market centers 24 can interact with the posting market center 20. The posting market center 20 is the market center on which a specific trader 26 posts a specific order, and on which a specific Market Maker 31 posts a specific quote. The posting market center 20 includes an order matching engine 21, which validates, matches and processes all orders and quotes on the posting market center 20. In this embodiment, the code for the order matching engine 21 is stored in the posting market center's memory.

The posting market center 20 may also include a quote and last sale interface 23 that interacts with the away market centers 24 to capture quote and last sale information. This information is stored to a best bids and offers and last sales data structure 25. This data structure 25 is where the market best bid and offer information is stored. This data structure 25 is also where the market trade reports (prints) are stored. The posting market center 20 may also include an order and trade parameters data structure 27. The order and trade parameters data structure 27 stores pre-defined trading parameters and rules that are used by the order matching engine 21 in matching orders and executing trades. The posting market center 20 may also include an order and execution interface 28 which interacts with the traders 26, the Market Makers 31, the away market centers 24 and the order matching engine 21 in the order execution process. The posting market center 20 may also include an order information data structure 29 where order information is stored and a trade information data structure 30 where completed trade information is stored. The posting market center 20 may also include a Market Maker interface 32 that interacts with Market Makers 31 to capture Market Maker bids and offers in assigned issues. These bids and offers are logically depicted in a Market Maker Quotes structure 33 in this illustration. In actuality, the Market Maker bids and offers may physically reside in the away market center best bids and offers data structure 25.

Throughout the discussion herein, it should be understood that the details regarding the operating environment, data structures, and other technological elements surrounding the posting market center 20 are by way of example and that the present invention may be implemented in various differing forms. For example, the data structures referred to herein may be implemented using any appropriate structure, data storage, or retrieval methodology (e.g., local or remote data storage in data bases, tables, internal arrays, etc.). Furthermore, a market center of the type described herein may support any type of suitable interface on any suitable computer system.

Order Matching Engine and Order Execution Processes

For every order type processed on the posting market center 20, the order matching engine 21 determines how to rank the order in its “internal book” according to whether the order is disclosed, partially disclosed or not disclosed at all to the marketplace. The internal book is a virtual book of all orders resting on the posting market center. For purposes of the examples in this document, the Top-of-Book best bid and offer (“BBO”) quotes from each protected away market center are also sometimes included in the internal book, regardless of whether they actually reside in a different table or not. In this embodiment, an order that is fully disclosed to the marketplace has higher matching priority than an order at the same price level that is partially disclosed or not disclosed, and trading interest resident on the posting market center always has priority over away market interest at the same price level.

The most common example of an order type that is fully disclosed is a simple limit order. The most common example of an order type that is partially disclosed and partially nondisclosed is an order with reserve shares (i.e. a Reserve Order). The Passive Liquidity Order of the present invention described herein is one of the few order types that is never disclosed (i.e. is completely hidden from the marketplace). Orders that must execute immediately (e.g., Market Orders and IOC orders) are not included in this discussion of order ranking.

By definition, a Passive Liquidity Order can only execute on the posting market center and does not route out to other away market centers. As a Passive Liquidity Order by definition has a nondisplayed size, reserve functionality is not available for this order type. Similarly, as a Passive Liquidity Order by definition has a nondisplayed price, discretionary functionality is also not available for this order type. As a Passive Liquidity Order is a limit-priced order by definition, it may not include pegging functionality to automatically track the NBBO. In a preferred, but not limiting, embodiment of the present invention, a Passive Liquidity Order also has a minimum, round lot size requirement, and is restricted against interacting with incoming orders or commitments routed by away markets to the posting market center 20. In a preferred, but not limiting, embodiment of the present invention, usage of a Passive Liquidity Order in some issues may be restricted to certain market participants, for example, may be limited to the Lead Market Maker in issues where the posting market center is the primary listings market.

In a preferred, but not limiting, embodiment of the present invention, if the price of the incoming passive liquidity order would lock or cross the market, the order may be either canceled immediately or else held until such time as it can be activated in the internal book without locking or crossing the market, as determined by the posting market center's business rules. In a different implementation of this invention, an incoming passive liquidity order may be allowed to join the lock or cross if the posting market center 20 is party to the lock/cross and the execution does not result in a trade-through violation.

When the order matching engine 21 of this embodiment of the present invention receives an incoming order, it delivers it to one of several Order Execution “Processes.” In this embodiment, there is a Display Process level and a Working Process level. The Working Process level in this embodiment, in turn, includes a Reserve Process sublevel, a Liquidity Process sublevel and a Discretion Process sublevel. Referring to the first level, the Display Process is at the heart of the posting market center order matching engine and effects the ranking of displayed nonmarketable limit orders on a strict price/time priority basis. The Working Process stores nondisplayed, nonmarketable resident trading interest, such as the nondisplayed size of Reserve Orders, the nondisplayed price of Discretionary Orders, and the completely nondisclosed Passive Liquidity Orders. At any given price level, displayed resident interest has priority over nondisplayed resident interest in this embodiment.

Working Process Sublevels: Reserve Process, Liquidity Process, and Discretion Process

In this embodiment, the three sublevels of the Working Process are employed as follows: the Reserve Process for reserve orders; the Liquidity Process for Passive Liquidity Orders; and the Discretion Process for discretionary orders. Within the Working Process, in this embodiment, at any given price level:
1. Reserve Orders have the highest trading priority;
2. Passive Liquidity Orders have the second-highest trading priority; and
3. Discretionary Orders have the third-highest trading priority.
   Market Maker Processes

If an issue has appointed Market Makers, the posting market center may also support a Lead Market Maker Guarantee Process and/or a Directed Order Process, wherein such processes would precede the Display and Working Processes. Market Maker quotes not eligible for execution in the Lead Market Maker Guarantee Process or the Directed Order Process are eligible for execution in the Display Process instead, where the quotes are ranked in strict price/time priority with displayed limit orders on the book. The matching priority of Passive Liquidity Orders in relation to Market Maker quotes is described in this document and illustrated by means of several examples.

Passive Liquidity Order Execution Priority on the Posting Market Center

When the order matching engine 21 processes a non-marketable order, it inserts the non-marketable order into the appropriate processing level of the posting market center order book according to the trading rules that govern that order type. In this embodiment, the order matching engine 21 determines the processing level that the received non-marketable order should be placed into according to the following rules:
Fully-disclosed orders are inserted in the Display Process only. Orders are ranked in the Display Process according to strict price/time priority;
Reserve Orders are inserted in the Display Process and the Working Process. The disclosed portion resides in the Display Process and is ranked according to strict price/time priority. The undisclosed (reserve) size resides in the Reserve Process sublevel, and is ranked according to the price/time priority of the displayed component;
Passive Liquidity Orders are inserted in the Working Process only. The entire order resides in the Liquidity Process sublevel. Passive Liquidity Orders are ranked according to strict price/time priority within the Liquidity Process; and
Discretionary Orders are inserted in the Display Process and the Working Process. The disclosed portion resides in the Display Process and is ranked according to strict price/time priority. The undisclosed (discretionary) price resides in the Discretion Process sublevel, and is ranked according to the price/time priority of the displayed component.

An exception to the price/time priority model described above exists for issues with assigned Market Makers. In some embodiments, under prescribed conditions, customer orders and/or Lead or Designated Market Makers quotes may be granted time priority over other trading interest at the same price.

It should be understood that the description of the ranked Order Execution Processes and sub-processes herein is only meant to illustrate the logical processing concepts and does not imply a physical implementation. The purpose of describing separate processes is to illustrate how various order types have priority over other order types within the order matching engine 21.

In this embodiment, when the order matching engine 21 acts to trade orders in the book, it attempts to execute an incoming order according to the priority of its Order Execution Processes. If an order is received in an issue that does not have appointed Market Makers, the order matching engine 21 attempts to execute in the Display Order Process first. If an order is received in an issue with appointed Market Makers, the order matching engine 21 generally attempts to execute in the Lead Market Maker Guarantee Process or the Directed Order Process first. If an order cannot be executed in either process, or if an order is partially executed but still has quantity remaining to trade, then the order matching engine 21 looks to the Display Process next. If orders reside in the Display Process level at the best price point, it matches those orders first. If the order matching engine 21 exhausts all orders in the Display Process level at that price point, then it moves to the Reserve Process level next. If it exhausts all orders in the Reserve Process level at that price point, then it moves to the Liquidity Process level next. If it exhausts all orders in the Liquidity Process level at that price point, then it moves to the Discretion Process level next. Other possible subsequent Order Execution Processes with lower priority (e.g., a Tracking Process and a Routing Process) are not discussed in this document.

The table below represents an embodiment of the buy side of the internal book of the posting market center 20 (an equivalent table exists for the sell side of the book):

| Price | | | | |
|---|---|---|---|---|
| point | Display | Reserve | Liquidity | Discretion |
| Price n | Highest priority | Second priority | Third priority | Fourth |
| | | | | priority |

Example: Ranking of Order Types at the Same Price Point

To illustrate how orders are conceptually inserted within each of these process levels, the following example starts with an empty book for the buy side which is then populated with different order types at the same price.

In this example, the posting market center 20 receives the following order:
Order A: Buy 1000 @ 20.00

As this order is to be fully disclosed, the order matching engine 21 inserts the order in the Display Process level only. The posting market center's internal book looks like this:

| Price | | | | |
|---|---|---|---|---|
| point | Display | Reserve | Liquidity | Discretion |
| 20.00 | A: 1000 @ 20.00 | | | |

The posting market center 20 next receives the Reserve Order below:
Order B: Buy 8000 @ 20.00, Show size=500, Reserve size=7500

As this order is to be partially disclosed (Show size=500) and partially non-disclosed (Reserve size=7500), the order matching engine 21 inserts the order in the Display Process level and the Reserve Process level. The book, at this point, looks like this:

| Price | | | | |
|---|---|---|---|---|
| point | Display | Reserve | Liquidity | Discretion |
| 20.00 | A: 1000 @ 20.00 | B: 7500 @ 20.00 | | |
| | B: 500 @ 20.00 | | | |

The posting market center 20, in this example, receives this order:
Order C: Buy 9000 @ 20.00, Passive Liquidity

The order matching engine 21 inserts this order in the Liquidity Process level.

The internal book looks like this:

| Price | | | | |
|---|---|---|---|---|
| point | Display | Reserve | Liquidity | Discretion |
| 20.00 | A: 1000 @ 20.00 | B: 7500 @ 20.00 | C: 9000 @ | |
| | | | 20.00 | |
| | B: 500 @ 20.00 | | | |

An incoming order to Sell 18,000 @ 20.00 would:
Trade all the orders in the Display Process level first (1000 shares of Order A, and 500 shares of Order B);
Trade all the orders in the Reserve Process level next (7500 reserve shares of Order B); and
Trade all the orders in the Liquidity Process level next (9000 shares of Order C).
   Example: Ranking of Order Types at Different Price Points

Even though the Passive Liquidity Orders of the present invention trade behind all orders with a displayed price, all orders are ranked first by price priority. This means a nondisplayed order trades ahead of displayed orders if the displayed orders are at inferior prices.

The posting market center 20 receives the following three orders:
Order A: Buy 1000 @ 20.00
Order B: Buy 8000 @ 20.00, Show size=500, Reserve size=7500
Order C: Buy 9000 @ 20.02, Passive Liquidity

The order matching engine 21 inserts Order A in the Display Process level at the price point of $20.00. It then inserts the 500 disclosed shares of Order B in the Display Process level at the price point of $20.00 and it inserts the 7500 reserve shares in the Reserve Process level at the price point of $20.00.

The order matching engine 21 inserts Order C in the Liquidity Process level at the price point of $20.02. It should be noted that even though the orders in the Liquidity Process level trade behind orders in the Display Process level and the Reserve Process level at the same price point, there are no orders in the Display Process or Reserve Process at the price point of $20.02. This means that, in this example, Order C has the highest matching priority within the internal book.

The internal book looks like this:

| Price | | | | |
|---|---|---|---|---|
| point | Display | Reserve | Liquidity | Discretion |
| 20.02 | | | C: 9000 @ | |
| | | | 20.02 | |
| 20.00 | A: 1000 @ 20.00 | B: 7500 @ 20.00 | | |
| | B: 500 @ 20.00 | | | |

The posting market center 20 receives an incoming order to Sell 5000 at $20.00. The order matching engine 21 does not look for buy orders at the price point of $20.00. Rather, it looks for buy orders starting at the best (highest) price point. In this case, the best price point is $20.02.

The order matching engine 21 first looks for orders at $20.02 in the Display Process level and finds none exist. Next, it looks for orders at $20.02 in the Reserve Process level and finds none exist. It then looks for orders at $20.02 in the Liquidity Process level and finds Order C available. It trades the incoming order (Sell 5000 @ 20.00) with the Passive Liquidity Order (Buy 9000 @ 20.02) at the price of $20.02, not $20.00, because the resting Passive Liquidity Orders of this embodiment do not receive price improvement unless required to prevent a trade-through, which is discussed in more detail below. Instead, the incoming order received the benefit of price improvement. The internal book looks like this after the trade:

| Price | | | | |
|---|---|---|---|---|
| point | Display | Reserve | Liquidity | Discretion |
| 20.02 | | | C: 4000 @ | |
| | | | 20.02 | |
| 20.00 | A: 1000 @ 20.00 | B: 7500 @ 20.00 | | |
| | B: 500 @ 20.00 | | | |

While it is typical that an incoming limit-priced order receives price improvement when its price crosses a contra-side limit order, an incoming Market Order typically executes at the NBBO price. In this example, the NBB is 20.00 due to the displayed prices of Order A and Order B. The posting market center 20 receives an incoming order to Sell 1000 at Market. Once again, the order matching engine 21 does not look for buy orders at the price point of $20.00, even though the NBB is $20.00. Rather, it looks for buy orders starting at the best (highest) price point. In this case, the best price point is $20.02.

The order matching engine 21 first looks for orders at $20.02 in the Display Process level and finds none exist. Next, it looks for orders at $20.02 in the Reserve Process level and finds none exist. It then looks for orders at $20.02 in the Liquidity Process level and finds Order C available. It trades the incoming order (Sell 1000 @ Market) with the Leaves quantity of the Passive Liquidity Order (Buy 4000 @ 20.02) at its specified limit price of $20.02, not the NBB price of $20.00, because the resting Passive Liquidity Orders of this embodiment do not receive price improvement unless required to prevent a trade-through. Instead, the incoming order received the benefit of price improvement. The internal book looks like this after the trade:

| Price | | | | |
|---|---|---|---|---|
| point | Display | Reserve | Liquidity | Discretion |
| 20.02 | | | C: 3000 @ | |
| | | | 20.02 | |
| 20.00 | A: 1000 @ 20.00 | B: 7500 @ 20.00 | | |
| | B: 500 @ 20.00 | | | |

Example: Ranking of Passive Liquidity Orders Compared to Orders with the Same Discretionary Price

Continuing from the previous example, the posting market center 20 receives a new Discretionary Buy order:
Order D: Buy 2000 @ 20.00, with discretion to 20.02

A Discretionary Order is another example of an order that has a disclosed component and a non-disclosed component. In this case, the disclosed component is the displayed price and size, and the non-disclosed component is the most aggressive price that the order is willing to “step up” to if necessary to effect a trade. This is its discretionary price.

The order matching engine 21 inserts Order D in the Display Process level as 2000 shares at the price point of $20.00, its display price. It also “inserts” links to Order D in the Discretion Process level at the price points up to and including $20.02, its discretionary price. Although in the Table below, Order D may appear to reside in multiple cells, it only resides in the Display Process, where it is ranked according to price/time priority like any other displayed order. The Table merely illustrates that Order D can also “step up” to the prices of 20.01 or 20.02 if necessary to effect a trade. The internal book conceptually looks like this:

| Price | | | | |
|---|---|---|---|---|
| point | Display | Reserve | Liquidity | Discretion |
| 20.02 | | | C: 3000 @ | D: 2000 @ 20.02 |
| | | | 20.02 | |
| 20.01 | | | | D: 2000 @ 20.01 |
| 20.00 | A: 1000 @ 20.00 | B: 7500 @ | | |
| | | 20.00 | | |
| | B: 500 @ 20.00 | | | |
| | D: 2000 @ 20.00 | | | |

The posting market center 20 receives an incoming order to sell 4000 at $20.02. The order matching engine 21 starts at its best price point of $20.02 and looks for orders at that price point in the Display Process level. It finds none exist, so it looks for orders at that price point in the Reserve Process level. It finds none exist, so it then looks for orders at that price point in the Liquidity Process level. The order matching engine 21 finds Order C (i.e. the Passive Liquidity Order) and retrieves it.

The order matching engine 21, therefore, trades 3000 shares of the incoming sell order with 3000 shares of Passive Liquidity Order C, filling Order C completely and removing it from the book.

The incoming sell order still has 1000 shares left to trade. The order matching engine 21 looks for more orders at the price point of $20.02 in the Liquidity Process and finds none. It then looks for orders at the price point of $20.02 in the Discretion Process level. It finds a link to Order D (i.e. the Discretionary Order) and retrieves Order D.

The order matching engine 21 trades the remaining 1000 shares of the incoming sell order with 1000 shares of Discretionary Order D at 20.02, its maximum discretionary price (Order D could not trade with the incoming sell order at a lower price, as the buy and sell prices would not overlap). As Order D still has 1000 shares remaining, the order matching engine 21 adjusts Order D's quantity in the Display Process level and in the Discretion Process level. The internal book looks like this after trading:

| Price | | | | |
|---|---|---|---|---|
| point | Display | Reserve | Liquidity | Discretion |
| 20.02 | | | | D: 1000 @ 20.02 |
| 20.01 | | | | D: 1000 @ 20.01 |
| 20.00 | A: 1000 @ 20.00 | B: 7500 @ | | |
| | | 20.00 | | |
| | B: 500 @ 20.00 | | | |
| | D: 1000 @ 20.00 | | | |

Example: Ranking of Passive Liquidity Orders Compared to Orders with a Superior Discretionary Price

In this example, the internal book starts out looking as indicated below:

| Price | | | | |
|---|---|---|---|---|
| point | Display | Reserve | Liquidity | Discretion |
| 20.02 | | | C: 3000 @ | |
| | | | 20.02 | |
| 20.00 | A: 1000 @ 20.00 | B: 7500 @ 20.00 | | |
| | B: 500 @ 20.00 | | | |

The posting market center 20 receives a new Discretionary Buy order:
Order D: Buy 2000 @ 20.00, with discretion to 20.03

The order matching engine 21 inserts Order D in the Display Process level as 2000 shares at the price point of $20.00, its display price. It also “inserts” links to Order D in the Discretion Process level at the price points up to and including $20.03, its discretionary price. Again, although in the Table below, Order D may appear to reside in multiple cells, it only resides in the Display Process, where it is ranked according to price/time priority like any other displayed order. The Table merely illustrates that it can also “step up” to the prices of $20.01, $20.02, or $20.03 if necessary to effect a trade. The internal book conceptually looks like this:

| Price | | | | |
|---|---|---|---|---|
| point | Display | Reserve | Liquidity | Discretion |
| 20.03 | | | | D: 2000 @ 20.03 |
| 20.02 | | | C: 3000 @ | D: 2000 @ 20.02 |
| | | | 20.02 | |
| 20.01 | | | | D: 2000 @ 20.01 |
| 20.00 | A: 1000 @ 20.00 | B: 7500 @ | | |
| | | 20.00 | | |
| | B: 500 @ 20.00 | | | |
| | D: 2000 @ 20.00 | | | |

The posting market center 20 receives an incoming order to Sell 4000 at $20.02. The order matching engine 21 starts at its best price point and looks for orders at that price point. Although in the Table that appears above, the best price point may appear to be 20.03, this is not the best price point in this example. This is because an order's discretionary price is not the same as a limit price per se—it is the maximum (minimum) price at which a discretionary buy (sell) Order will “step up” to trade. However, an order cannot use discretion to step ahead of other orders that are also marketable against an incoming order. Discretionary Orders can only use as much discretion as required to effect a trade. In contrast, the Passive Liquidity Order will always trade at its limit price unless that price would cause a trade-through violation.

When determining its best price point, the matching engine 21 does not start with the Discretionary Process, it only executes in the Discretionary Process if it cannot execute an incoming order in the Display, Reserve, or Liquidity Processes. For example, if the order matching engine 21 received an order to Sell 2000 @ 20.03, then it would indeed determine that its best price point is 20.03 because only Discretionary Order D could trade at that price.

Thus, with the incoming sell order priced at $20.02, the order matching engine 21 starts at its best price point of $20.02 and looks for orders at that price point in the Display Process level. It finds none exist, so it looks for orders at that price point in the Reserve Process level. It finds none exist, so it then looks for orders at that price point in the Liquidity Process level. The order matching engine 21 finds Order C (i.e. the Passive Liquidity Order) and retrieves it.

The order matching engine 21, therefore, trades 3000 shares of the incoming sell order with 3000 shares of Passive Liquidity Order C at $20.02, filling Order C completely and removing it from the book.

The incoming sell order still has 1000 shares left to trade. The order matching engine 21 looks for more orders at the price point of $20.02 in the Liquidity Process and finds none. It then looks for orders at the price point of $20.02 in the Discretion Process level. It finds Order D (i.e. the Discretionary Order) and retrieves it.

The order matching engine 21 trades the remaining 1000 shares of the incoming sell order with 1000 shares of Discretionary Order D at $20.02, the price that uses the least amount of discretion but still allows it to trade. As Order D still has 1000 shares remaining, the order matching engine 21 adjusts Order D's quantity in the Display Process level and in the Discretion Process level. The internal book conceptually looks like this after the trades:

| Price | | | | |
|---|---|---|---|---|
| point | Display | Reserve | Liquidity | Discretion |
| 20.03 | | | | D: 1000 @ 20.03 |
| 20.02 | | | | D: 1000 @ 20.02 |
| 20.01 | | | | D: 1000 @ 20.01 |
| 20.00 | A: 1000 @ 20.00 | B: 7500 @ | | |
| | | 20.00 | | |
| | B: 500 @ 20.00 | | | |
| | D: 1000 @ 20.00 | | | |

As illustrated, and explained, in the preceding example, an incoming order to sell at $20.02 trades identically regardless of whether the posted Discretionary Order is priced at $20.02 or $20.03. In both cases, the Passive Liquidity Order priced at $20.02 has priority over the Discretionary Order.

Example: Ranking of Passive Liquidity Orders in the Directed Order Process

This example illustrates the priority of a Passive Liquidity Order compared to a Market Maker's Directed Fill in an equities trading environment. In this example, a Market Maker has a standing instruction with the posting market center 20 that the order matching engine 21 automatically generate a Directed Fill in response to a marketable Directed Order received from a permissioned user. For the purposes of this example, a Directed Fill has a size and price specified by the Market Maker. For this example, the internal book contains the following orders:
Order A: Buy 1000 @ 20.00
Order B: Buy 8000 @ 20.00, Show Size=500, Reserve Size=7500

Order C: Buy 1000 @ 20.02, Passive Liquidity Order

| Price | | | | |
|---|---|---|---|---|
| point | Display | Reserve | Liquidity | Discretion |
| 20.02 | | | C: 1000 @ | |
| | | | 20.02 | |
| 20.01 | | | | |
| 20.00 | A: 1000 @ 20.00 | B: 7500 @ 20.00 | | |
| | B: 500 @ 20.00 | | | |

In this example, the NBBO is 20.00 to 20.03, when the following valid Directed Order is received from a user who is permissioned to direct orders to Market Maker MM1:
Sell 2000 @ 20.00, directed to Market Maker MM1

In this example, the Market Maker MM1 has a standing instruction with the posting market center 20 to buy 2000 at $20.01. In this example, the order matching engine 21, upon receiving the Directed Order for Market Maker MM1, automatically generates a Directed Fill priced at $20.01, a penny better than the posting market center Best Bid ($20.00) and also a penny better than the NBB ($20.00).

However, Passive Liquidity Order C has the highest priority for trading with an incoming order, regardless of whether that order is a non-directed order or a Directed Order. As such, Order C executes first because at its price of $20.02, it has price priority over the Directed Fill ($20.01) generated on behalf of Market Maker MM I.

As Order C is not eligible for price improvement in this example (because it can execute without trading through the NBO of $20.03), the incoming Directed Order matches all 1000 shares of Order C at Order C's price of $20.02, completely filling Order C and removing it from the internal book. The incoming Directed Order, therefore, has received price improvement.

After matching with Order C, the incoming Directed Order matches its 1000 remaining shares against the Directed Fill automatically generated on behalf of Market Maker MM1 at the Directed Fill price of $20.01. The incoming Directed Order receives price improvement on this portion of the trade execution as well.

In a different implementation of the Directed Order Process, the posting market center 20 may allow registered Market Makers to create a virtual book of “Guarantee Orders” instead of using standing instructions to dynamically generate Directed Fills. In such an implementation of the Directed Order Process, if Market Maker MM1 had a Guarantee Order to Buy 2000 at $20.01 in its virtual book, the results would be essentially the same as described above. An incoming Directed Order to sell 2000 at $20.00 with Market Maker MM1 would first match all 1000 shares of Passive Liquidity Order C at its price of $20.02 and would then match the remaining 1000 shares against Market Maker MM1's virtual Guarantee Order at $20.01. After trading, Market Maker MM1's virtual Guarantee Order would still have 1000 shares available to trade.

As illustrated in these examples, a Directed Order is executed against the Directed Fill or the Virtual Guarantee Order of the designated Market Maker, unless there is a Passive Liquidity Order with a superior price to that of the Directed Fill or Virtual Guarantee Order, in which case the Passive Liquidity Order has price priority and executes ahead of the inferior-priced Directed Order or Virtual Guarantee Order in the Directed Order Process.

Example: Ranking of a Passive Liquidity Order Compared to Market Maker Quotes in the Lead Market Maker Guarantee Process

This example illustrates the priority of a Passive Liquidity Order compared to Market Maker Quotes 33 in an options trading environment. In this example, Market Makers 31 may send quotes only for issues in which they are assigned. In this example, the internal book contains the following orders:
Order A: Buy 100 @ 1.95
Order B: Buy 800 @ 1.95, Show Size=50, Reserve Size=750
Order C: Buy 100 @ 2.05, Passive Liquidity Order

The internal book looks like this:

| Price | | | | |
|---|---|---|---|---|
| point | Display | Reserve | Liquidity | Discretion |
| 2.05 | | | C: 100 @ | |
| | | | 2.05 | |
| 1.95 | A: 100 @ 1.95 | B: 750 @ 1.95 | | |
| | B: 50 @ 1.95 | | | |

In this example, the Market Maker Quote Book 33 includes the following bids, where LMM 31a is the Lead Market Maker, and MM2 and MM3 are regular Market Makers. In this example, the quotes are prioritized according to their timestamps in the sequence shown below:

| Market Maker ID | Bids |
|---|---|
| MM2 | Bid 200 @ 2.00 |
| LMM | Bid 300 @ 2.00 |
| MM3 | Bid 300 @ 2.00 |

The NBBO in this example is 2.00 to 2.10 (800×800). The posting market center 20 receives the following order:
Sell 500 @ 2.00

Passive Liquidity Order C has the highest priority for trading with an incoming order, as it has price priority over all the Market Maker bids as well as Order A and Order B. The incoming sell order matches 100 contracts of Order C at $2.05, completely filling the order and removing it from the internal book. As Lead Market Maker LMM is quoting at the NBB (2.00), LMM is entitled to step ahead of MM2 to trade up to a specified guaranteed percentage (e.g., 40% in this example) in the Lead Market Maker Guarantee Process. The incoming sell order matches 160 contracts (40% of its remaining 400 contracts) against LMM at $2.00 in this example. The internal book now looks like this:

| Price | | | | |
|---|---|---|---|---|
| point | Display | Reserve | Liquidity | Discretion |
| 2.05 | | | | |
| 1.95 | A: 100 @ 1.95 | B: 750 @ 1.95 | | |
| | B: 50 @ 1.95 | | | |

The Market Maker Quote Book now looks like this:

| Market Maker ID | Bids |
|---|---|
| MM2 | Bid 200 @ 2.00 |
| LMM | Bid 140 @ 2.00 |
| MM3 | Bid 300 @ 2.00 |

After the incoming order trades in the Lead Market Maker Guarantee Process, its remaining 240 contracts trade in the Display Process according to normal price/time priority rules:
200 contracts match Market Maker MM2's quote @ 2.00, as MM2 has time priority over LMM and MM3; and
40 contracts match Market Maker LMM's quote @ 2.00, as LMM has time priority over MM3
   Example: Ranking of Passive Liquidity Order Compared to Market Maker Quotes in the Directed Order Process

In this example, in an options trading environment, a Market Maker who is not the Lead Market Maker is granted the same privileges for guaranteed participation according to the rules of the Directed Order Process. In this example, the internal book looks as it did at the beginning in the Lead Market Maker Guarantee Process example above:

| Price | | | | |
|---|---|---|---|---|
| point | Display | Reserve | Liquidity | Discretion |
| 2.05 | | | C: 100 @ | |
| | | | 2.05 | |
| 1.95 | A: 100 @ 1.95 | B: 750 @ 1.95 | | |
| | B: 50 @ 1.95 | | | |

The Market Maker Quote Book includes the same following bids, where LMM is the Lead Market Maker and MM2 and MM3 are regular Market Makers. In this example also, the quotes are prioritized according to their timestamps as follows:

| Market Maker ID | Bids |
|---|---|
| MM2 | Bid 200 @ 2.00 |
| LMM | Bid 300 @ 2.00 |
| MM3 | Bid 300 @ 2.00 |

The NBBO is 2.00 to 2.10 (800×800). In this example, the Directed Order Process is operable on the posting market center 20. An order sending firm 26b is permissioned to direct orders to the Market Maker firm MM3 31b, and sends the following Directed Order:
Sell 500 @ 2.00, directed to Market Maker MM3

Passive Liquidity Order C executes against this Directed Sell Order first because Order C has price priority over all the Market Maker bids. As such, the incoming Directed Order executes 100 contracts against Order C at $2.05, completely filling the order and removing it from the internal book. As designated Market Maker MM3 is quoting at the NBB ($2.00), MM3 is entitled to step ahead of MM2 and LMM to trade up to a specified guaranteed percentage (e.g., 40% in this example) in the Directed Order Process. The incoming order matches 160 contracts (40% of its remaining 400 contracts) against MM3 at $2.00 in this example. The internal book now looks like this:

| Price | | | | |
|---|---|---|---|---|
| point | Display | Reserve | Liquidity | Discretion |
| 2.05 | | | | |
| 1.95 | A: 100 @ 1.95 | B: 750 @ 1.95 | | |
| | B: 50 @ 1.95 | | | |

The Market Maker Quote Book now looks like this:

| Market Maker ID | Bids |
|---|---|
| MM2 | Bid 200 @ 2.00 |
| LMM | Bid 300 @ 2.00 |
| MM3 | Bid 140 @ 2.00 |

After the incoming order trades in the Directed Order Process, its remaining 240 contracts trade in the Display Process according to normal price/time priority rules:
200 contracts match Market Maker MM2's quote @ 2.00; and
40 contracts match Market Maker LMM's quote @ 2.00

As illustrated in the preceding examples, in this embodiment of the invention, a superior-priced Passive Liquidity Order trumps any matching privileges that may be granted to a Market Maker whose price is inferior, even when such Market Maker is guaranteed participation in a trade. Price priority, in this embodiment, is always enforced. An incoming order is executed against the quote of the Lead or designated Market Maker, unless there is a Passive Liquidity Order with a superior price to that of the Market Maker quote, in which case the Passive Liquidity Order has price priority and executes ahead of the inferior-priced Market Maker quote in the Lead Market Maker Guarantee Process (if the incoming order is not directed) or in the Directed Order Process (if the incoming order is directed).

It should be noted that the preceding examples are only by way of explanation in regard to the priority of Passive Liquidity Orders in comparison to Market Maker quotes, Directed Fills, or their functional equivalents (e.g., Virtual Guarantee Orders). The Directed Order Process and/or the Lead Market Maker Guarantee Process may be implemented in a manner that differs from what is described in these examples, without altering the fundamental principle that a Passive Liquidity Order with a superior price executes ahead of a Market Maker quote (or its functional counterpart) with an inferior price. A Market Maker quote executes ahead of a Passive Liquidity Order only if the Passive Liquidity Order's price is equal or inferior to the same.

Incoming Passive Liquidity Buy Order is Received

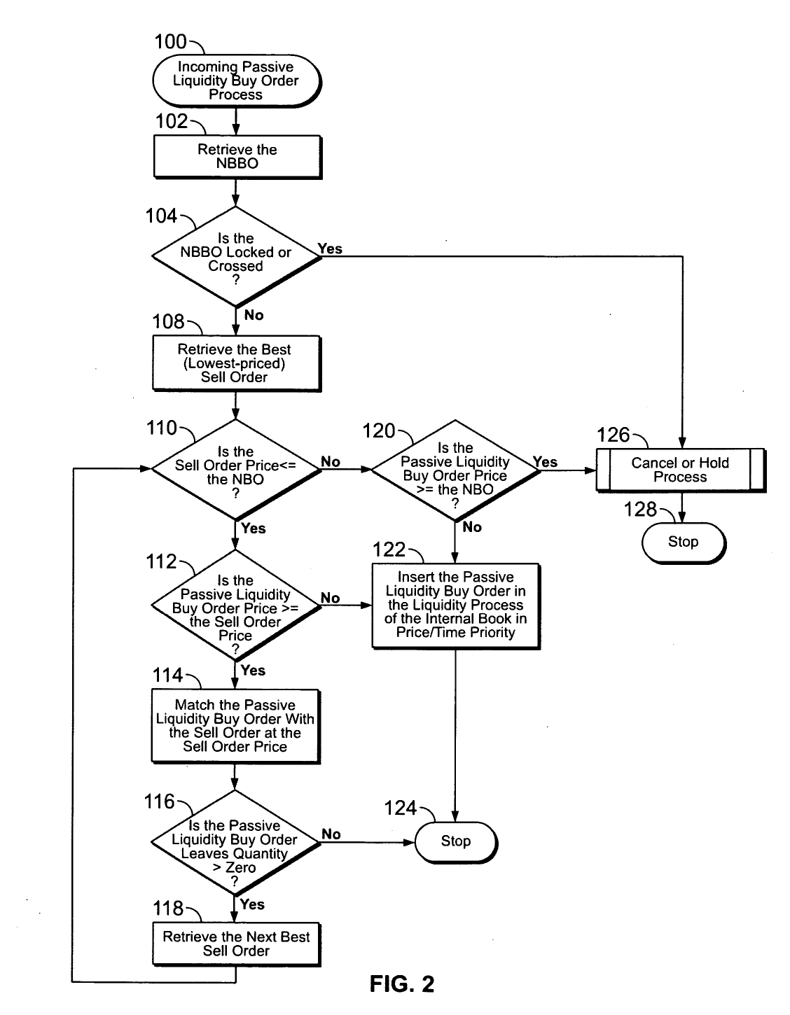

FIG. 2 illustrates the process implemented by the order matching engine 21 when a trader 26 sends a Passive Liquidity Buy Order to the posting market center 20. The order matching engine 21, in this embodiment, first checks to see whether the national best bid and offer (“NBBO”) is locked (i.e., NBB higher than NBO) or crossed (i.e., NBB equal to NBO) because a Passive Liquidity Order may not join the lock or cross, nor can it trade through the NBBO. To this end, at step 102, the process retrieves the NBBO and checks whether it is locked or crossed in step 104.

If the NBBO is locked or crossed, then the process proceeds to step 126, where it invokes the “Cancel Or Hold” process, which is described in detail below. According to the posting market center's business rules for this order type, the order must either be either canceled immediately or else it must be held until such time as it could be activated in the posting market center's internal book without locking or crossing the market. The decision whether to cancel the order or hold the order is implemented by means of a configurable CancelOrHold parameter which may be set differently according to the type of issue.

Returning to step 104, if the NBBO is not locked or crossed, then the process continues to step 108 and checks to see if the incoming Passive Liquidity Buy Order is marketable against the posting market center's internal book by retrieving the best (lowest-priced) Sell Order. The process, at this point, compares the retrieved Sell Order price to the national best offer (“NBO”), as indicated at step 110.

If the process determines the retrieved Sell Order price is not less than or equal to the NBO, then the incoming Passive Liquidity Buy Order cannot trade with the offer side of the posting market center book because it cannot trade through the NBO to match the Sell Order, even if the Buy Order and Sell Order prices overlap. Continuing to step 120, the process then compares the price of the incoming Passive Liquidity Buy Order to the NBO to determine if the order can be inserted in the posting market center's internal book without locking or crossing the NBO, even though such lock or cross would not be displayed to the marketplace.

If the process determines in step 120 that the Passive Liquidity Buy Order price is not greater than or equal to the NBO, then the Buy Order does not lock or cross the market and is inserted in the “hidden” Liquidity Process level of the posting market center's internal book, as indicated at step 122. As previously described, the Liquidity Process is a sublevel of the Working Process. Since Passive Liquidity Orders are not displayed, the order is not displayed on the posting market center's public order book. As indicated at step 124, the process stops at this point.

Referring again to step 120, if the process determines that the price of the Passive Liquidity Buy Order is greater than or equal to the NBO, the process proceeds to the “Cancel Or Hold” process, as indicated at step 126, and described in detail below, to determine how this order should be processed. The Passive Liquidity Order must be canceled or held at this point because it presently crosses or locks the market.

Referring back to step 110, if the process determines the retrieved Sell Order price is less than or equal to the NBO, then the incoming Passive Liquidity Buy Order can potentially trade against the offer side of the posting market center's order book. At step 112, the process determines whether the price of the incoming Passive Liquidity Buy Order is greater than or equal to the retrieved Sell Order price. If the price of the Passive Liquidity Buy Order is not greater than or equal to the retrieved Sell Order price, then the Buy Order is not marketable and is inserted into the Liquidity Process level of the posting market center's internal book, as indicated at step 122. Since Passive Liquidity Orders are not displayed, the order is not displayed on the posting market center's public order book. As indicated at step 124, the process stops at this point.

Referring back to step 112, if the process determines that the price of the incoming Passive Liquidity Buy Order is greater than or equal to the retrieved Sell Order price, then the Buy Order can execute against the Sell Order, and the process proceeds to step 114 where it matches the incoming Passive Liquidity Buy Order with the retrieved Sell Order at the Sell Order price. After matching the incoming Buy Order and the retrieved Sell Order, the process checks to see if the incoming Buy Order still has quantity remaining, as indicated at step 116. If the Passive Liquidity Buy Order does have quantity remaining to be traded, the process continues to step 118, where it retrieves the next-best Sell Order from the internal book. The process returns to step 110, and follows the same process as described above to determine if the Passive Liquidity Buy Order can execute against the next-best Sell Order or whether it needs to be inserted into the Liquidity Process level of the posting market center's internal book. Referring to step 116 again, if the process determines that there is no quantity remaining on the incoming Passive Liquidity Buy Order, then the process is complete, and it stops as indicated at step 124.

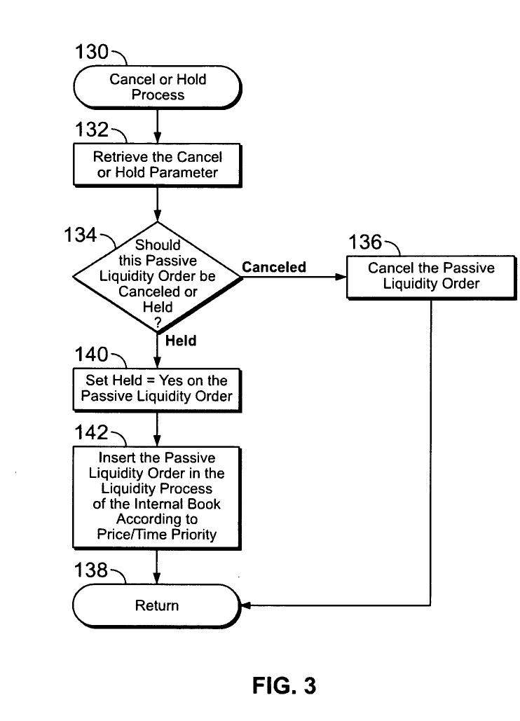

Referring to FIG. 3, the “CancelOrHold” process referred to above is illustrated. At step 132, the process retrieves the “CancelOrHold” parameter for this issue, and, at step 134, determines whether the parameter is set to “Cancel” or set to “Hold”. If the “CancelOrHold” parameter is set to “Cancel”, the Passive Liquidity Order is canceled as indicated at step 136, and the process continues to step 138 where it returns to the main routine being executed. Referring back to step 134, if the process determines that the “CancelOrHold” parameter is set to “Hold”, then the process sets the “Held” parameter to “Yes” on the incoming Passive Liquidity Order, as indicated at step 140. In this implementation of the invention, the “Held” Passive Liquidity Order is inserted into the Liquidity Process level of the posting market center's internal book, as indicated at step 142. Although it is included in the internal book, a Passive Liquidity Order cannot trade with an incoming order as long as it is “Held”. In a different implementation, the “Held” Passive Liquidity Order may be queued in a separate table instead until such time as it can be included in the internal book as an active order. The process at this point continues to step 138 as well, where it returns to the main routine being executed.

Incoming Sell Order May be Executable Against a Resting Passive Liquidity Buy Order

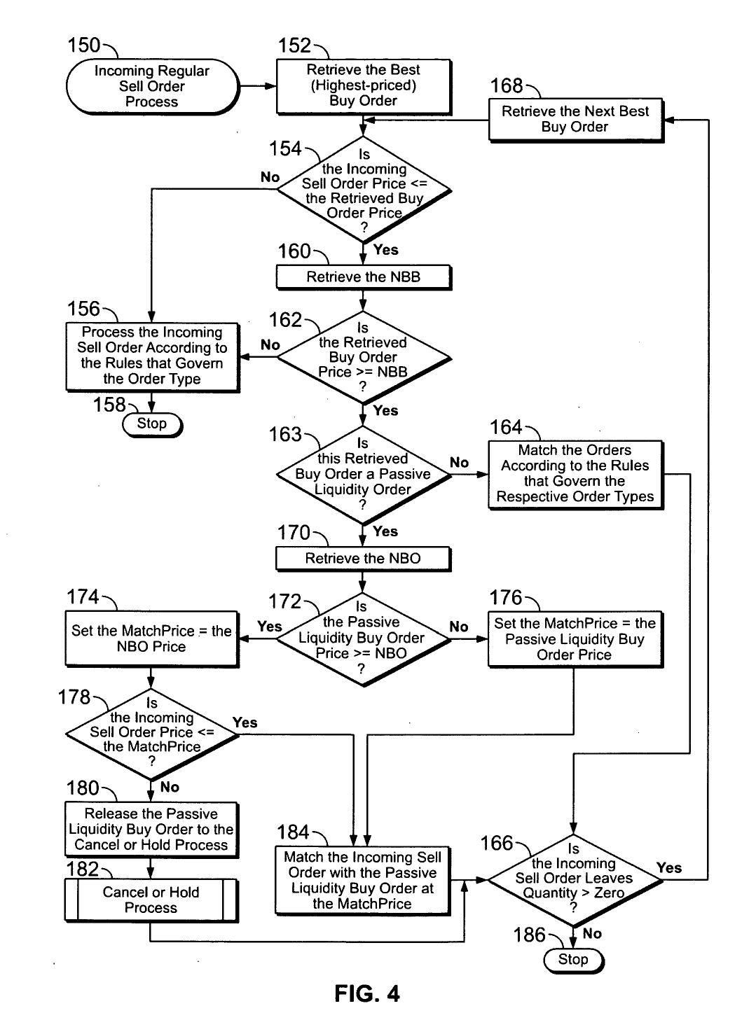

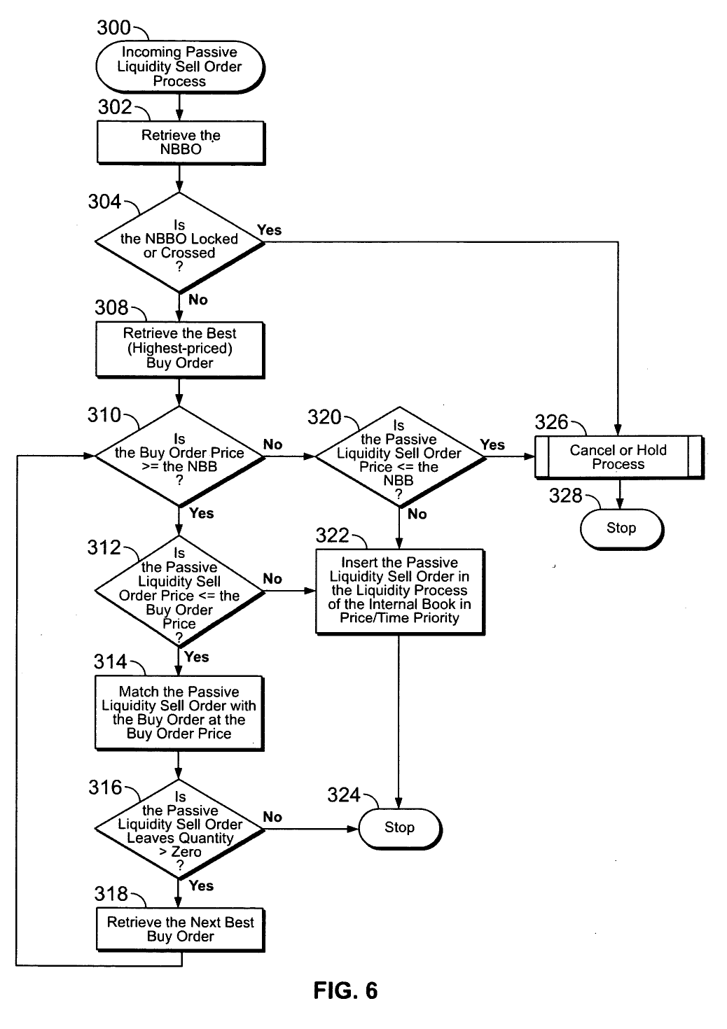

Referring to FIG. 4, an embodiment of the process for when the posting market center 20 receives an incoming sell order that is not also a Passive Liquidity Order is illustrated (the process for incoming Passive Liquidity Sell Orders is illustrated in FIG. 6). The purpose of this Figure is to illustrate how a regular (i.e. non-Passive Liquidity) incoming sell order executes against a resting Passive Liquidity Buy Order. The order matching engine process 21 is activated. The process retrieves the best (highest-priced) Buy Order from the internal book, as indicated at step 152. The process then compares the price of the retrieved Buy Order to the price of the incoming Sell Order, as indicated at step 154. If the price of the incoming Sell Order is not less than or equal to the retrieved Buy Order, the order prices do not overlap, and the Sell Order is processed according to the normal rules that govern the order type (for example, it may be canceled, posted, or routed to a superior away market), as indicated at step 156, and the process stops, as indicated at step 158.

Referring back to step 154, if the price of the incoming Sell Order is less than or equal to the retrieved Buy Order price, then the process proceeds to step 160, where it retrieves the NBB. At step 162, the process compares the retrieved Buy Order's price to the NBB. If the Buy Order's price is less than the NBB, then the incoming Sell Order cannot match it without trading through an away market, so the process proceeds to steps 156 and 158, where the Sell Order is processed according to the normal rules that govern the order type (as described above) until the process terminates.

Returning to step 162, if however, the retrieved Buy Order's price is greater than or equal to the NBB, then the incoming Sell Order is eligible to match it. At step 163, the process determines if the retrieved Buy Order is a Passive Liquidity Order. If it is not, then the incoming Sell Order and retrieved Buy Order are matched with one another according to the normal trading rules that govern their order types, as indicated at step 164. The process then checks to determine if the incoming Sell Order still has quantity remaining at step 166. If the Sell Order does have quantity remaining, the process continues to step 168, where it retrieves the next-best Buy Order in the internal book. The process then returns to step 154 and processes the remaining portion of the Sell Order as described above. On the other hand, if the incoming Sell Order has been completely filled, then the process stops as indicated at step 186.

Referring back to step 163, if the retrieved Buy Order is a Passive Liquidity Order, then the process proceeds to step 170, where it determines the relationship between the price of the retrieved Passive Liquidity Buy Order and the NBO and sets a “match price” capped by the NBO, if necessary, so that the retrieved Passive Liquidity Buy Order does not trade through the NBO. Passive Liquidity Orders in this embodiment cannot trade through the NBBO. Although as illustrated in FIG. 2, incoming Passive Liquidity Buy Orders are checked to be sure they do not lock or cross the NBO, it is possible that once a Passive Liquidity Buy Order is already active in the internal book, the NBO has subsequently moved to or through its price. To this end, the process retrieves the NBO at step 170. At step 172, the process determines whether the price of the Passive Liquidity Buy Order is greater than or equal to the NBO.

If at step 172, the price of the Passive Liquidity Buy Order is not greater than or equal to the NBO, the process sets the “MatchPrice” parameter equal to the specified limit price of the Passive Liquidity Buy Order at step 176, indicating that it trades without price improvement. The process then matches the incoming Sell Order with the resting Passive Liquidity Buy Order at the “MatchPrice”, as indicated at step 184. After doing this, the process checks to see if the incoming Sell Order has any quantity remaining at step 166. If it does, the process retrieves the next-best resting Buy Order at step 168 and then returns to step 154 and repeats the process described above all over again.

Returning to step 172, if the price of the Passive Liquidity Buy Order is greater than or equal to the NBO, the process sets the “MatchPrice” parameter equal to the NBO, as indicated at step 174. This process caps the “match price” of the Passive Liquidity Buy Order so that when it trades, it will not trade through the NBO. By definition, Passive Liquidity Orders are normally not entitled to price improvement. This step, however, illustrates the exception where the price of a Passive Liquidity Buy Order must be improved to prevent a trade-through violation.

After setting the “MatchPrice” parameter, the process then proceeds to step 178 where it determines whether the incoming Sell Order can still trade against the resting Passive Liquidity Buy Order after the Buy Order's price has been capped at step 174. In this regard, if the Sell Order price is not less than or equal to the determined “MatchPrice” parameter, this means the orders cannot match because their prices no longer overlap. Since the orders cannot match, nor can they be allowed to lock or cross the posting market center's own order book, the “Cancel Or Hold” process is implemented as indicated at steps 180 and 182 for the resting Passive Liquidity Buy Order, which can no longer be treated as an active order. The incoming Sell Order is then checked to see if it has any quantity remaining to be traded, as indicated at step 166. If the Sell Order does have quantity remaining, the process retrieves the next-best resting Buy Order at step 168 and then returns to step 154 and starts the process over again.

Referring again to step 178, if the incoming Sell Order price is less than or equal to the “MatchPrice” parameter, then the process matches the incoming Sell Order with the resting Passive Liquidity Buy Order at the “MatchPrice”, as indicated at step 184. After doing this, as with other steps in the process, the process checks to see if the incoming Sell Order has any quantity remaining at step 166. If it does, the process retrieves the next-best resting Buy Order at step 168 and then returns to step 154 and repeats the process described above all over again.

Re-Evaluating the Status of “Held” Passive Liquidity Buy Orders

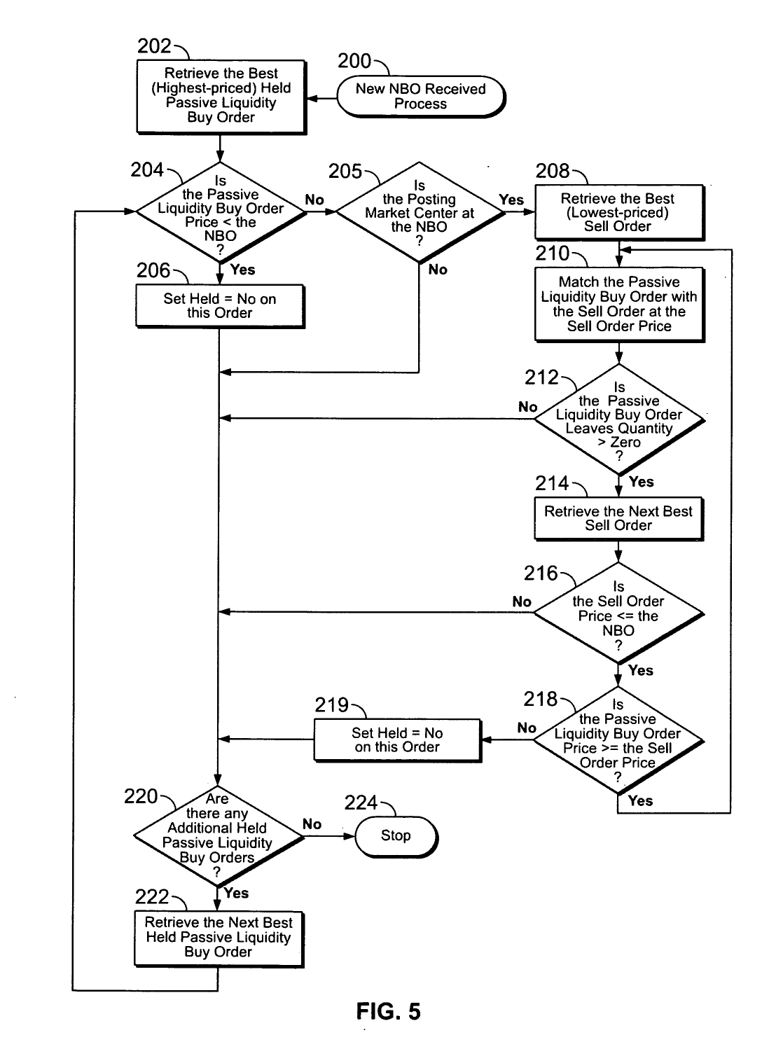

Referring to FIG. 5, when the process detects a new NBO, it checks to see if any “Held” Passive Liquidity Buy orders can be released based on the new NBO price. It should be noted that the process is invoked only if the new NBO is less aggressive than the previous NBO, (i.e., if the new NBO price has moved higher) and the new NBBO is not locked or crossed. When a new NBO is detected, it is possible that “Held” Passive Liquidity Buy Orders can now be released because their prices would no longer lock or cross the market. It is also possible that “Held” Passive Liquidity Buy Orders can now trade with resting Sell Orders on the posting market without trading through any superior away market offers.

At step 202, the process retrieves the best (highest-priced) Passive Liquidity Buy Order with a “Held” parameter set to “Yes.” At step 204, the process then compares the price of the retrieved Passive Liquidity Buy Order to the NBO. If the retrieved Passive Liquidity Buy Order's price is lower than the NBO, then the order can be released without locking or crossing the market, and the process sets its “Held” parameter to “No” at step 206. After the “Held” order has been released, the process proceeds to step 220, where it checks whether there are any additional “Held” Passive Liquidity Buy Orders that can also be released. If no additional “Held” Passive Liquidity Buy Orders exist, then the process stops at step 224 as shown. However, if there are additional “Held” Passive Liquidity Buy Orders in the internal book, then the process retrieves the next-best “Held” order at step 222 and returns to step 204 and follows the same process described above to determine if it can also be released. As the orders are ranked in price/time priority, if the best-priced “Held” Passive Liquidity Buy Order is released, then all other lower ranked “Held” Passive Liquidity Buy Orders will also be released because their prices will not lock or cross the market either.

Referring again to step 204, if the NBO is not higher than the price of the “Held” Passive Liquidity Buy Order, then the process proceeds to step 205, where it checks whether the posting market center 20 is at the NBO, as the retrieved “Held” Passive Liquidity Buy Order can trade with resting sell orders if they are at the new NBO price. On the other hand, if at step 205, the posting market center is not at the NBO, then the retrieved “Held” Passive Liquidity Buy Order is not released because it cannot trade, nor can it be allowed to lock or cross the NBO. In this case, the process continues to step 220 to see if there are any additional “Held” Passive Liquidity Buy Orders that can be reevaluated instead. Even though the currently evaluated “Held” Passive Liquidity Buy Order cannot be released, other “Held” Passive Liquidity Buy Orders with inferior prices (i.e., ranked lower in the internal book) are more likely to be able to be released without locking or crossing the market. If additional “Held” Passive Liquidity Buy Orders do exist, then the process continues to step 222, where it retrieves the next-best “Held” Passive Liquidity Buy Order. Returning to step 220, if no additional “Held” Passive Liquidity Buy Orders exist, then the process is completed at step 224.

Returning to step 205, if the posting market center is at the NBO, then the “Held” Passive Liquidity Buy Order can execute against one or more resting sell orders on the posting market center. At step 208, the process retrieves the best (lowest-priced) Sell Order. At step 210, the process matches the “Held” Passive Liquidity Buy Order with the retrieved Sell Order at the Sell Order price. At step 212, the process checks whether the “Held” Passive Liquidity Buy Order has any quantity remaining. If it does have quantity remaining, then the process retrieves the next-best Sell Order at step 214, and at step 216, the process checks whether this next-best Sell Order is also at or better than the NBO. If it is, then the Sell Order can also be matched without trading through an away market. At step 218, the process compares the “Held” Passive Liquidity Buy Order's price to the retrieved Sell Order's price. If the prices overlap, then the process returns to step 210 again and the “Held” Passive Liquidity Buy Order matches the next-best retrieved Sell Order at the Sell Order price.

Returning to step 212, if the “Held” Passive Liquidity Buy Order does not have any quantity remaining, then the process proceeds to step 220, where it checks whether there are any additional “Held” Passive Liquidity Buy Orders. Once again, if additional “Held” Passive Liquidity Buy Orders do exist, then the process continues to step 222, where it retrieves the next-best “Held” Passive Liquidity Buy Order and returns to step 204 and follows the same process described above to determine if it can be released. However, if no additional “Held” Passive Liquidity Buy Orders exist, then the process is completed at step 224.

Returning to step 216, if the next-best retrieved Sell Order is not less than or equal to the NBO, then the “Held” Passive Liquidity Buy Order cannot match it without trading through an away market. In this case, the process proceeds to step 220, where it checks whether there are any additional “Held” Passive Liquidity Buy Orders. Once again, if additional “Held” Passive Liquidity Buy Orders do exist, then the process continues to step 222, where it retrieves the next-best “Held” Passive Liquidity Buy Order and returns to step 204 and follows the same process described above to determine if it can be released. However, if no additional “Held” Passive Liquidity Buy Orders exist, then the process is completed at step 224.

Returning to step 218, it is possible that even if the retrieved Sell Order is determined to be at the NBO price at the previous step 216, the latest Sell Order price may not overlap with the price of the “Held” Passive Liquidity Buy Order. This can happen if this newest retrieved Sell Order has a price that is inferior to the previous retrieved Sell Order. If at step 218 the process does determine that the “Held” Passive Liquidity Buy Order price is lower than the retrieved Sell Order price, then at step 219 the process sets the “Held” parameter to “No” on this Passive Liquidity Buy Order to release it. The orders cannot match because there is no overlap in prices, but because they do not overlap, the “Held” Passive Liquidity Buy Order can be released without locking or crossing the posting market center's internal book. The process continues to step 220 to see if there are any additional “Held” Passive Liquidity Buy Orders in the internal book, and retrieves the next “Held” order at step 222 if one exists or else stops at step 224 if no additional “Held” orders exist.

The process finally concludes after all “Held” Passive Liquidity Buy Orders whose prices do not lock or cross the market are released. As described above, the marketable Passive Liquidity Buy Order(s) will trade against sell orders resident on the posting market center. The nonmarketable released Passive Liquidity Buy Orders are activated in the posting market center's internal book, where they are now eligible to trade against incoming sell orders.

Incoming Passive Liquidity Sell Order is Received

FIG. 6 illustrates the process implemented by the order matching engine 21 when a trader at an order sending firm 26 sends a Passive Liquidity Sell Order to the posting market center 20. The order matching engine 21, in this embodiment, first checks to see whether the NBBO is locked or crossed because a Passive Liquidity Order may not join the lock or cross, nor can it trade through the NBBO. To this end, at step 302, the process retrieves the NBBO and checks whether it is locked or crossed in step 304.

If the NBBO is locked or crossed, then the process proceeds to step 326, where it invokes the “Cancel Or Hold” process, which is described in detail above. According to the posting market center's business rules for this order type, the order must either be either canceled immediately or else it must be held until such time as it could be included in the posting market center's internal book without locking or crossing the market. The decision whether to cancel the order or hold the order is implemented by means of a configurable CancelOrHold parameter which may be set differently according to the type of issue.

Returning to step 304, if the NBBO is not locked or crossed, then the process continues to step 308 and checks to see if the incoming Passive Liquidity Sell Order is marketable against the posting market center's internal book by retrieving the best (highest-priced) Buy Order. The process, at this point, compares the retrieved Buy Order price to the NBB, as indicated at step 310.

If the process determines the retrieved Buy Order price is not greater than or equal to the NBB, then the incoming Passive Liquidity Sell Order cannot trade with the bid side of the posting market center book because it cannot trade through the NBB to match the Buy Order, even if the Sell Order and Buy Order prices overlap. Continuing to step 320, the process then compares the price of the incoming Passive Liquidity Sell Order to the NBB to determine if the order can be inserted in the posting market center's internal book without locking or crossing the NBB, even though such lock or cross would not be displayed to the marketplace.

If the process determines at step 320 that the Passive Liquidity Sell Order price is not less than or equal to the NBB, then the Sell Order does not lock or cross the market and is inserted in the “hidden” Liquidity Process level of the posting market center's internal book, as indicated at step 322. As previously described, the Liquidity Process is a sub-process of the Working Process. Since Passive Liquidity Orders are not displayed, the order is not displayed on the posting market center's public order book. As indicated at step 324, the process stops at this point.

Referring again to step 320, if the process determines that the price of the Passive Liquidity Sell Order is less than or equal to the NBB, the process proceeds to the “CancelOrHold” process, as indicated at step 326, and previously described in detail above, to determine how this order should be processed. The Passive Liquidity Order must be canceled or held at this point because it presently crosses or locks the market.

Referring back to step 310, if the process determines the retrieved Buy Order price is greater than or equal to the NBB, then the incoming Passive Liquidity Sell Order can potentially trade against the bid side of the posting market center's order book. At step 312, the process determines whether the price of the Passive Liquidity Sell Order is less than or equal to the retrieved Buy Order price. If the price of the Passive Liquidity Sell Order is not less than or equal to the retrieved Buy Order price, then the Sell Order is not marketable and is inserted into the Liquidity Process level of the posting market center's internal book, as indicated at step 322. Since Passive Liquidity Orders are not displayed, the order is not displayed on the posting market center's public order book. As indicated at step 324, the process stops at this point.

Referring back to step 312, if the process determines that the price of the incoming Passive Liquidity Sell Order is less than or equal to the retrieved Buy Order price, then the Sell Order can execute against the Buy Order, and the process proceeds to step 314 where it matches the incoming Passive Liquidity Sell Order with the retrieved Buy Order at the Buy Order price. After matching the incoming Sell Order and the retrieved Buy Order, the process checks to see if the incoming Sell Order still has quantity remaining, as indicated at step 316. If the Passive Liquidity Sell Order does have quantity remaining to be traded, the process continues to step 318, where it retrieves the next-best Buy Order from the internal book. The process returns to step 310 and follows the same process as described above to determine if the Passive Liquidity Sell Order can execute against the next-best Buy Order or whether it needs to be inserted into the Liquidity Process level of the posting market center's internal book. Referring to step 316 again, if the process determines that there is no quantity remaining on the incoming Passive Liquidity Sell Order, then the process is complete, and it stops as indicated at step 324.

Incoming Buy Order May be Executable Against a Resting Passive Liquidity Sell Order

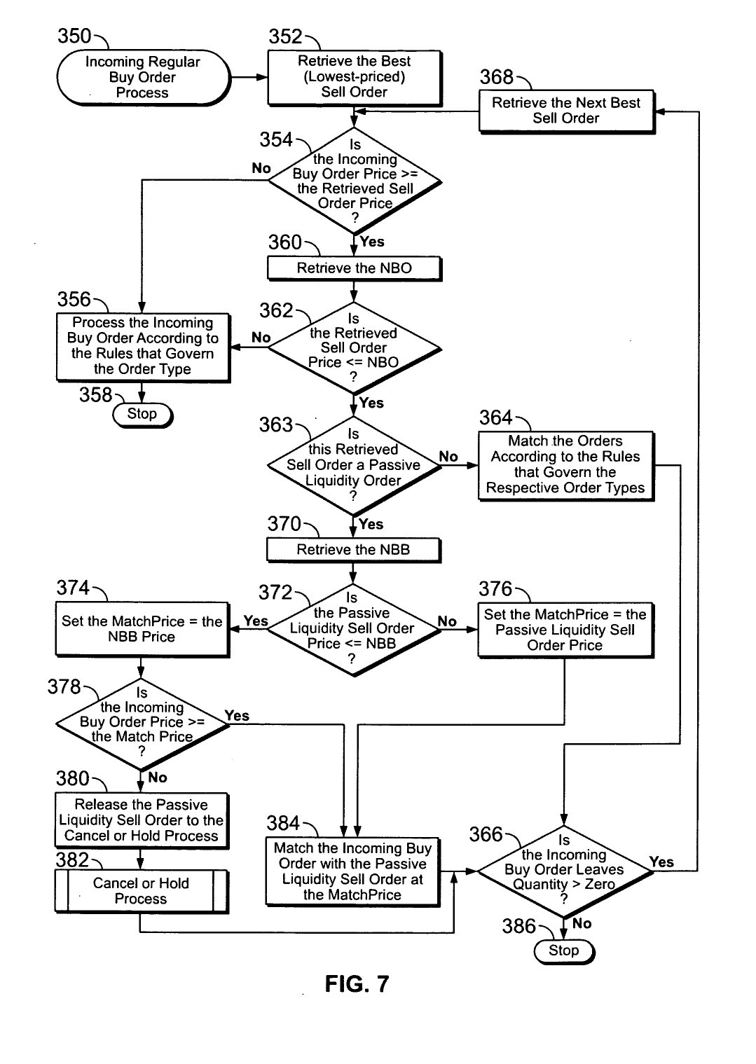

Referring to FIG. 7, an embodiment of the process for when the posting market center 20 receives an incoming buy order that is not also a Passive Liquidity Order is illustrated (the process for incoming Passive Liquidity Buy Orders is illustrated in FIG. 2). This figure illustrates how a regular (i.e. non-Passive Liquidity) incoming buy order executes against a resting Passive Liquidity Sell Order. The order matching engine process 21 is activated. The process retrieves the best (lowest-priced) Sell Order from the internal book, as indicated at step 352. The process then compares the price of the retrieved Sell Order to the price of the incoming Buy Order, as indicated at step 354. If the price of the incoming Buy Order is not greater than or equal to the retrieved Sell Order, the order prices do not overlap, and the Buy Order is processed according to the normal rules that govern the order type (for example, it may be canceled, posted, or routed to a superior away market), as indicated at step 356, and the process terminates at step 358.

Referring back to step 354, if the price of the incoming Buy Order is greater than or equal to the retrieved Sell Order price, then the process proceeds to step 360, where it retrieves the NBO. At step 362, the process compares the price of the retrieved Sell Order to the NBO. If the retrieved Sell Order's price is higher than the NBO, then the incoming Buy Order cannot match it without trading through an away market, so the process proceeds to steps 356 and 358, where the Buy Order is processed according to the normal rules that govern the order type until the process terminates.

Referring back to step 362, if however, the retrieved Sell Order's price is less than or equal to the NBO, then the incoming Buy Order is eligible to match it. At step 363, the process determines if the retrieved Sell Order is a Passive Liquidity Order. If it is not, then the incoming Buy Order and retrieved Sell Order are matched with one another according to the normal trading rules that govern their order types, as indicated at step 364. The process then checks to determine if the incoming Buy Order still has quantity remaining at step 366. If the Buy Order does have quantity remaining, the process continues to step 368, where it retrieves the next-best Sell Order in the internal book. The process then returns to step 354 and processes the remaining portion of the Buy Order as described above. On the other hand, if the incoming Buy Order has been completely filled, then the process stops as indicated at step 386.

Referring back to step 363, if the retrieved Sell Order is a Passive Liquidity Order, then the process proceeds to step 370, where it determines the relationship between the price of the retrieved Passive Liquidity Sell Order and the NBB and sets a “match price” capped by the NBB, if necessary, so that the retrieved Passive Liquidity Sell Order does not trade through the NBB. Passive Liquidity Orders in this embodiment cannot trade through the NBBO. Although as illustrated in FIG. 6, incoming Passive Liquidity Sell Orders are checked to be sure they do not lock or cross the NBB, it is possible that once a Passive Liquidity Sell Order is active in the internal book, the NBB has subsequently moved to or through its price. To this end, the process retrieves the NBB at step 370. At step 372, the process determines whether the price of the Passive Liquidity Sell Order is less than or equal to the NBB.

If at step 372, the price of the Passive Liquidity Sell Order is not less than or equal to the NBB, the process sets the “MatchPrice” parameter equal to the specified limit price of the Passive Liquidity Sell Order at step 376, indicating that it trades without price improvement. The process then matches the incoming Buy Order with the resting Passive Liquidity Sell Order at the “MatchPrice”, as indicated at step 384. After doing this, the process checks to see if the incoming Buy Order has any quantity remaining at step 366. If it does, the process retrieves the next-best resting Sell Order at step 368 and then returns to step 354 and repeats the process described above all over again.

Returning to step 372, if the price of the Passive Liquidity Sell Order is less than or equal to the NBB, the process sets the “MatchPrice” parameter equal to the NBB, as indicated at step 374. This process caps the “match price” of the Passive Liquidity Sell Order so that when it trades, it will not trade through the NBB. By definition, Passive Liquidity Orders are normally not entitled to price improvement. This step, however, illustrates the exception where the price of a Passive Liquidity Sell Order must be improved to prevent a trade-through violation.

After setting the “MatchPrice” parameter, the process then proceeds to step 378 where it determines whether the incoming Buy Order can still trade against the resting Passive Liquidity Sell Order after the Sell Order's price has been capped at step 374. In this regard, if the Buy Order price is not greater than or equal to the determined “MatchPrice” parameter, this means the orders cannot match because their prices no longer overlap. Since the orders cannot match, nor can they be allowed to lock or cross the posting market center's own order book, the “CancelOrHold” process is implemented as indicated at steps 380 and 382 for the resting Passive Liquidity Sell Order, which can longer be treated as an active order. The incoming Buy Order is then checked to see if it has any quantity remaining to be traded, as indicated at step 366. If the Buy Order does have quantity remaining, the process retrieves the next-best resting Sell Order at step 368 and then returns to step 354 and starts the process over again.

Referring again to step 378, if the incoming Buy Order price is greater than or equal to the “MatchPrice” parameter, then the process matches the incoming Buy Order with the resting Passive Liquidity Sell Order at the “MatchPrice”, as indicated at step 384. After doing this, as with other steps in the process, the process checks to see if the incoming Buy Order has any quantity remaining at step 366. If it does, the process retrieves the next-best resting Sell Order at step 368 and then returns to step 354 and repeats the process described above all over again.

Re-Evaluating the Status of “Held” Passive Liquidity Sell Orders

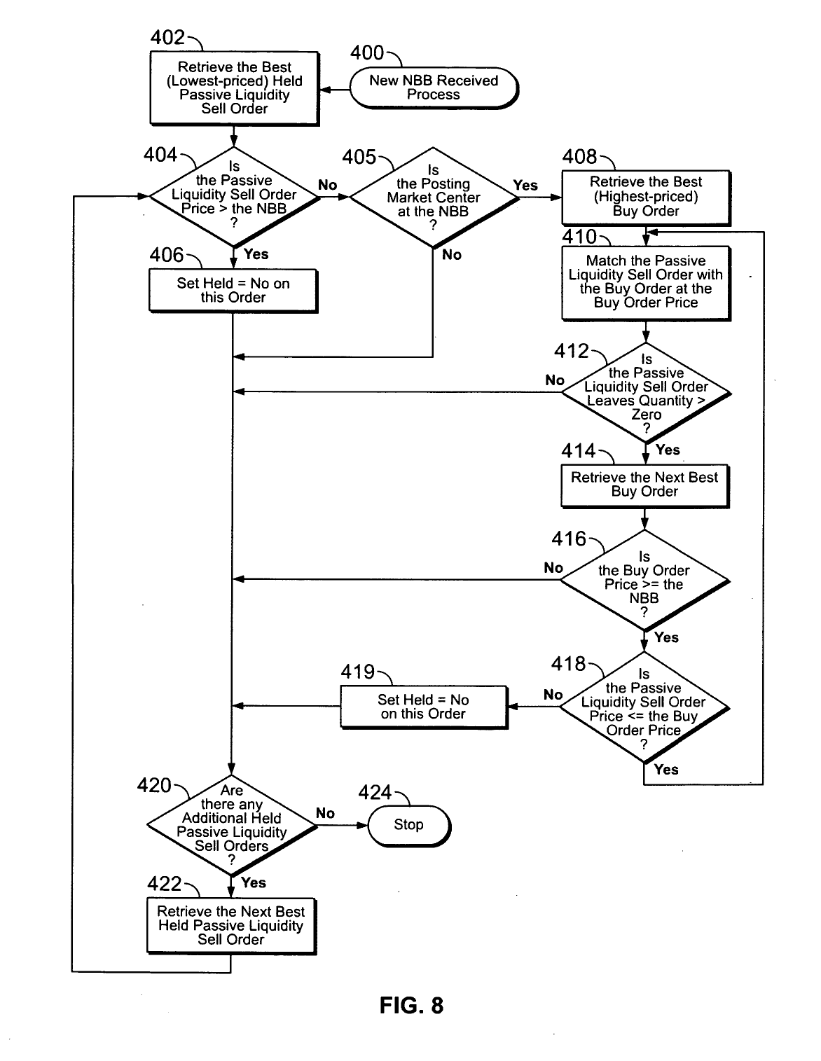

Referring to FIG. 8, when the process detects a new NBB, it checks to see if any “Held” Passive Liquidity Sell orders can be released based on the new NBB price. It should be noted that the process is invoked only if the new NBB is less aggressive than the previous NBB, (i.e., if the new NBB price has moved lower) and if the new NBBO is not locked or crossed. When a new NBB is detected, it is possible that “Held” Passive Liquidity Sell Orders can now be released because their prices would no longer lock or cross the market. It is also possible that “Held” Passive Liquidity Sell Orders can now trade with resting Buy Orders on the posting market center without trading through any superior away market bids.

At step 402, the process retrieves the best (lowest-priced) Passive Liquidity Sell Order with a “Held” parameter set to “Yes.” At step 404, the process then compares the price of the retrieved Passive Liquidity Sell Order to the NBB. If the retrieved Passive Liquidity Sell Order's price is higher than the NBB, then the order can be released without locking or crossing the market, and the process sets its “Held” parameter to “No” at step 406. After the “Held” order has been released, the process proceeds to step 420, where it checks whether there are any additional “Held” Passive Liquidity Sell Orders that can also be released. If no additional “Held” Passive Liquidity Sell Orders exist, then the process stops at step 424 as shown. However, if there are additional “Held” Passive Liquidity Sell Orders in the internal book, then the process retrieves the next-best “Held” order at step 422 and returns to step 404 and follows the same process described above to determine if it can also be released. As the orders are ranked in price/time priority, if the best-priced “Held” Passive Liquidity Sell Order is released, then all other lower ranked “Held” Passive Liquidity Sell Orders will also be released because their prices will not lock or cross the market either.

Returning to step 404, if the price of the “Held” Passive Liquidity Sell Order is not higher than the NBB, then the process proceeds to step 405, where it checks whether the posting market center 20 is at the NBB, as the retrieved “Held” Passive Liquidity Sell Order can trade with resting buy orders if they are at the new NBB price. On the other hand, if at step 405, the posting market center is not at the NBB, then the retrieved “Held” Passive Liquidity Sell Order is not released because it cannot trade, nor can it be allowed to lock or cross the NBB. In this case, the process continues to step 420 to see if there are any additional “Held” Passive Liquidity Sell Orders that can be reevaluated instead. Even though the currently evaluated “Held” Passive Liquidity Sell Order cannot be released, other “Held” Passive Liquidity Sell Orders with inferior prices (i.e., ranked lower in the internal book) are more likely to be able to be released without locking or crossing the market. If additional “Held” Passive Liquidity Sell Orders do exist, then the process continues to step 422, where it retrieves the next-best “Held” Passive Liquidity Sell Order and returns to step 404 where it repeats the process described above to determine if the order can be released. Returning to step 420, if no additional “Held” Passive Liquidity Sell Orders exist, then the process is completed at step 424.

Returning to step 405, if the posting market center is at the NBB, then the “Held” Passive Liquidity Sell Order can execute against one or more resting buy orders on the posting market center. At step 408, the process retrieves the best (highest-priced) Buy Order. At step 410, the process matches the “Held” Passive Liquidity Sell Order with the retrieved Buy Order at the Buy Order price. At step 412, the process checks whether the “Held” Passive Liquidity Sell Order has any quantity remaining. If it does have quantity remaining, then the process retrieves the next-best Buy Order at step 414, and at step 416, the process checks whether this next-best Buy Order is also at or better than the NBB. If it is, then the Buy Order can also be matched without trading through an away market. At step 418, the process compares the “Held” Passive Liquidity Sell Order's price to the retrieved Buy Order's price. If the prices overlap, then the process returns to step 410 again and the “Held” Passive Liquidity Sell Order matches this next-best retrieved Buy Order at the Buy Order price.

Returning to step 412, if the “Held” Passive Liquidity Sell Order does not have any quantity remaining, then the process proceeds to step 420, where it checks whether there are any additional “Held” Passive Liquidity Sell Orders. Once again, if additional “Held” Passive Liquidity Sell Orders do exist, then the process continues to step 422, where it retrieves the next-best “Held” Passive Liquidity Sell Order and returns to step 404 and follows the same process described above to determine if it can be released. However, if no additional “Held” Passive Liquidity Sell Orders exist, then the process is completed at step 424.

Returning to step 416, if the next-best retrieved Buy Order is not greater than or equal to the NBB, then the “Held” Passive Liquidity Sell Order cannot match it without trading through an away market. In this case, the process proceeds to step 420, where it checks whether there are any additional “Held” Passive Liquidity Sell Orders. Once again, if additional “Held” Passive Liquidity Sell Orders do exist, then the process continues to step 422, where it retrieves the next-best “Held” Passive Liquidity Sell Order and returns to step 404 and follows the same process described above to determine if it can be released. However, if no additional “Held” Passive Liquidity Sell Orders exist, then the process is completed at step 424.

Returning to step 418, it is possible that even if the retrieved Buy Order is determined to be at the NBB price at the previous step 416, the latest Buy Order price may not overlap with the price of the “Held” Passive Liquidity Sell Order. This can happen if this newest retrieved Buy Order has a price that is inferior to the previous retrieved Buy Order. If at step 418 the process does determine that the “Held” Passive Liquidity Sell Order price is higher than the retrieved Buy Order price, then at step 419 the process sets the “Held” parameter to “No” on this Passive Liquidity Sell Order to release it. The orders cannot match because there is no overlap in prices, but because they do not overlap, the “Held” Passive Liquidity Sell Order can be released without locking or crossing the posting market center's internal book. The process continues to step 420 to see if there are any additional “Held” Passive Liquidity Sell Orders in the internal book, and retrieves the next “Held” order at step 422 if one exists or else stops at step 424 if no additional “Held” orders exist.

The process finally concludes after all “Held” Passive Liquidity Sell Orders whose prices do not lock or cross the market are released. As described above, the marketable Passive Liquidity Sell Orders will trade against buy orders resident on the posting market center. The nonmarketable released Passive Liquidity Sell Orders are activated in the posting market center's internal book, where they are now eligible to trade against incoming buy orders.

Examples of how Passive Liquidity Orders of this embodiment operate are provided below. It should be understood that the order and quote prices and sizes discussed in these examples are by way of example only to illustrate how the process of an embodiment of the invention handles Passive Liquidity Orders. Passive Liquidity Order behavior is not limited to these examples. For illustration purposes, in the examples below, the Passive Liquidity Orders are shown in “reverse-display” to indicate their status as nondisplayed orders. The examples that follow next illustrate how Passive Liquidity Orders trade on an equities marketplace.

### EXAMPLE 1

### Nonmarketable Passive Liquidity Buy Order is Received

In this example, the following orders are posted to the internal book of the posting market center 20 at the start:
Order 1: Buy 8000 @ 20.00, Show size=500, Reserve size=7500
Order 2: Buy 1000 @ 20.00
Order 3: Sell 600 @ 20.04

Away Market Center A has disseminated a bid to buy 300 at $20.00 and an offer to sell 400 at $20.03.
The NBBO is 20.00 to 20.03 (1800×400)

The internal book looks like this:

| Bids | Offers |
|---|---|
| Order 1: 500 @ 20.00 | MarketA: 400 @ 20.03 |
| Show size = 500, | |
| Reserve size = 7500 | |
| Order 2: 1000 @ 20.00 | Order 3: 600 @ 20.04 |
| MarketA: 300 @ 20.00 | |

The public order book, which only shows disclosed shares, looks like this:

| Bids | Offers |
|---|---|
| Posting Market Center 1500 @ 20.00 | Posting Market Center |
| | 600 @ 20.04 |

In this example, the posting market center 20 receives the following order:
Order 4: Buy 2000 @ 20.02, Passive Liquidity

Referring to FIG. 2, when the posting market center 20 receives this incoming Passive Liquidity Buy Order, the order matching engine process 21 is activated. The process, as described above, retrieves the NBBO at step 102 and checks whether the NBBO is locked or crossed at step 104. If the NBBO is locked or crossed, then the process continues to step 126, where it invokes the “Cancel Or Hold” process, as the incoming Passive Liquidity Order must either be canceled immediately or else held until such time as the NBBO becomes unlocked and uncrossed, depending on the business rules of the posting market center. In this example, the NBBO ($20.00 to $20.03) is not locked or crossed when the order is received, so the incoming Passive Liquidity Buy Order can continue to be processed.

Since the NBBO is not locked or crossed in this example, the process checks to see whether the received buy order is marketable. In this regard, at steps 108 and 110, the process retrieves the lowest-priced Sell Order (i.e. Order 3 in this example) and determines whether the retrieved Sell Order price ($20.04) is less than or equal to the NBO ($20.03). The retrieved Sell Order price, in this example, is not less than or equal to the NBO. It is actually higher than the NBO. Because the retrieved Sell Order price is higher than the NBO, it is ineligible to trade with any incoming Passive Liquidity Buy Order due to trade-through restrictions.

The process proceeds to step 120 where the process determines whether the price of the incoming Passive Liquidity Buy Order ($20.02) is greater than or equal to the NBO ($20.03). In this example, the Passive Liquidity Buy Order price ($20.02) is not greater than or equal to the NBO ($20.03). It is lower. The Passive Liquidity Buy Order, as result, can be included in the internal book without locking or crossing the market. The process, therefore, inserts Passive Liquidity Buy Order 4 into the internal book in the Liquidity Process level, a “hidden” sublevel of the Working Process, as indicated at step 122. As Passive Liquidity Orders are not displayed, the order is not published to the posting market center's public order book, and the process is complete, as indicated at step 124.

The internal book looks like this:

| Bids | | Offers | |
|---|---|---|---|
| Order 4: | 2000 @ 20.02 [symbol] | MarketA: | 400 @ 20.03 |
| | Liquidity Process | | |
| Order 1: | 500 @ 20.00 | Order 3: | 600 @ 20.04 |
| | Show size = 500, | | |
| | Reserve size = 7500 | | |
| Order 2: | 1000 @ 20.00 | | |
| MarketA: | 300 @ 20.00 | | |

The public order book remains unchanged and looks like this:

| Bids | Offers |
|---|---|
| Posting Market Center 1500 @ 20.00 | Posting Market Center |
| | 600 @ 20.04 |

### EXAMPLE 2

### Resting Passive Liquidity Buy Order Trades with Incoming Sell Order

In this example, the posting market center 20 receives the following order:
Order 6: Sell 1000@20.00

Referring to FIG. 4, the process, at step 152, retrieves the highest-priced buy order, which is Passive Liquidity Buy Order 4 at $20.02. The process compares this order to the price of incoming Sell Order 6 ($20.00), as indicated at step 154. As the prices overlap, the process retrieves the NBB ($20.00) at step 160, and compares Passive Liquidity Buy Order 4's price ($20.02) to the NBB at step 162. As Order 4's price is higher, the process continues to step 163, where it determines whether the Buy Order is a Passive Liquidity Order. It is.

As Passive Liquidity Orders cannot trade through the NBBO, the process sets the highest price that the Passive Liquidity Buy Order can trade at. At step 170, the process retrieves the NBO and compares the price of Passive Liquidity Buy Order 4 ($20.02) to the NBO ($20.03), as indicated at step 172. The Passive Liquidity Buy Order price is lower than the NBO in this example, so the process sets the “MatchPrice” equal to $20.02, the specified limit price of Passive Liquidity Buy Order 4, as indicated at step 176.

At step 184, the process matches incoming Sell Order 6 with Passive Liquidity Buy Order 4 at $20.02. The match is priced at $20.02 because, again, Passive Liquidity Orders of this embodiment do not receive price improvement unless it is required to prevent a trade-through of an away market. As Away Market Center A is presently offering at $20.03, the match at $20.02 does not trade through its price.

The process, at steps 166 and 186, determines that incoming Sell Order 6 has no remaining shares to trade, and its processing is complete. The remaining 1000 shares of Passive Liquidity Buy Order 4 continue to reside in the Liquidity process, as they had prior to the posting market center 20 receiving incoming Sell Order 6.

The internal book now looks like this:

| Bids | | Offers | |
|---|---|---|---|
| Order 4: | 1000 @ 20.02 [symbol] | MarketA: | 400 @ 20.03 |
| | Liquidity Process | | |
| Order 1: | 500 @ 20.00 | | |
| | Show size = 500, | | |
| | Reserve size = 7500 | | |
| Order 2: | 1000 @ 20.00 | | |
| MarketA: | 300 @ 20.00 | | |

Since Passive Liquidity Order 4 is a nondisplayed order, the public order book remains unchanged.

### EXAMPLE 3

### Away Market Center Locks/Crosses the Buy Orders

Away Market Center A changes its bid to 300 at $19.99, and changes its offer to 400 at $20.00. The new offer locks posted Buy Orders 1 and 2, and crosses Passive Liquidity Buy Order 4. Away Market Center A and the marketplace are not aware of the cross since Buy Order 4 is not displayed.
The NBBO is locked (1500 @ 20.00 to 400 @ 20.00).

When an away market locks or crosses the posting market BBO, the posting market center 20 is allowed to “stand its ground” and not respond. This means it is not required to move its price, nor is it required to route to the offending market center.

The posting market center internal book looks like this:

| Bids | | Offers | |
|---|---|---|---|
| Order 4: | 1000 @ 20.02 | MarketA: | 400 @ 20.00 [symbol] |
| | Liquidity Process | | |
| Order 1: | 500 @ 20.00 | Order 3: | 600 @ 20.04 |
| | Show size = 500, | | |
| | Reserve size = 7500 | | |
| Order 2: | 1000 @ 20.00 | | |
| MarketA: | 300 @ 19.99 [symbol] | | |

The public order book remains unchanged.

### EXAMPLE 4

### Resting Passive Liquidity Buy Order Cannot Trade without Price Improvement

In this example, the posting market center 20 receives the following order:
Order 7: Sell 400 @ 20.00

Referring to FIG. 4, the process retrieves the highest-priced Buy Order at step 152, which in this example is Passive Liquidity Buy Order 4 at $20.02. The process, at step 154, compares the price of retrieved Buy Order 4 ($20.02) to the price of incoming Sell Order 7 ($20.00). As the prices overlap, the process retrieves the NBB ($20.00) at step 160 and compares the price of Passive Liquidity Buy Order 4 ($20.02) to the NBB at step 162. As Order 4's price is higher, the process then determines whether the retrieved Buy Order is a Passive Liquidity Order at step 163. It is in this example.

Therefore, to ensure that Passive Liquidity Buy Order 4 does not trade through the NBO, the process then retrieves the NBO at step 170 and, at step 172, compares the price of the Passive Liquidity Buy Order 4 ($20.02) to the NBO ($20.00). In this example, the Passive Liquidity Buy Order price is higher than the NBO, so the process sets the “MatchPrice” to $20.00, the NBO price, at step 174, so that Passive Liquidity Buy Order 4 does not trade through the NBO.

The process then compares the incoming Sell Order price ($20.00) to the designated “MatchPrice” of $20.00, at step 178. In this example, the prices are equal, so the process, at step 184, matches the incoming Sell Order 7 with Passive Liquidity Buy Order 4 at the designated “MatchPrice” of $20.00.

The process continues on to step 166 where it determines that, after matching with Passive Liquidity Buy Order 4, incoming Sell Order 7 has no shares remaining to trade and processing is complete for this Order at step 186. The remaining 600 shares of Passive Liquidity Buy Order 4 continue to reside in the Liquidity process level of the internal book.

This example illustrates how this embodiment of the present invention enforces the rules that Passive Liquidity Orders must be price improved if they would cause a trade-through violation if executed at their specified limit price. If the process were to have traded the order at $20.02 (i.e. the specified limit price of the Passive Liquidity Buy Order), Away Market Center A's offer of $20.00 would have been traded through.

The internal book now looks like this:

| Bids | | Offers | |
|---|---|---|---|
| Order 4: | 600 @ 20.02 [symbol] | MarketA: | 400 @ 20.00 |
| | Liquidity Process | | |
| Order 1: | 500 @ 20.00 | Order 3: | 600 @ 20.04 |
| | Show size = 500, | | |
| | Reserve size = 7500 | | |
| Order2: | 1000 @ 20.00 | | |
| MarketA: | 300 @ 19.99 | | |

The public order book remains unchanged.

### EXAMPLE 5

### Incoming Passive Liquidity Buy Order Would Lock the NBO

For this next example, Away Market Center A changes its bid to 300 at $20.00 and changes its offer to 400 at $20.01.
The NBBO is 20.00 to 20.01 (1800×400)

The internal book looks like this:

| Bids | | Offers | |
|---|---|---|---|
| Order 4: | 600 @ 20.02 | MarketA: | 400 @ 20.01 [symbol] |
| | Liquidity Process | | |
| Order 1: | 500 @ 20.00 | Order 3: | 600 @ 20.04 |
| | Show size = 500, | | |
| | Reserve size = 7500 | | |
| Order 2: | 1000 @ 20.00 | | |
| MarketA: | 300 @ 20.00 [symbol] | | |

The public order book remains unchanged.

In this example, the posting market center 20 receives the following order:
Order 8: Buy 3000 @ 20.01, Passive Liquidity

Referring to FIG. 2, when the posting market center 20 receives an incoming Passive Liquidity Buy Order, the activated process retrieves the NBBO ($20.00 to $20.01) in step 102 and checks to see if it is locked or crossed in step 104. As the NBBO is not locked or crossed, the process then continues to determine whether the incoming Passive Liquidity Buy Order is marketable. At step 108, the process retrieves the lowest-priced sell order (i.e. Order 3 in this example). The process then compares the Sell Order price ($20.04) to the NBO ($20.01) at step 110.

Since, in this example, the Sell Order price is higher than the NBO, the Passive Liquidity Buy Order cannot trade through the NBO to match it, even if the buy and sell prices overlapped, which they do not in this example. The process, at step 120, next compares the price of incoming Passive Liquidity Buy Order 8 ($20.01) to the NBO ($20.01) to determine if the buy order can be included in the internal book for subsequent matching. The Passive Liquidity Buy Order price, in this example, is the same as the NBO. So, the order cannot be included in the internal book as an active order because it would proactively lock Away Market A's offer. This is not allowed by the rules governing this order type, even considering the fact that the lock would not be publicly disseminated. Since Passive Liquidity Buy Order 8 cannot be inserted in the Liquidity Process level of the posting market center's order book as an active order, the process proceeds to step 126, where it invokes the “Cancel Or Hold” routine.

In this routine, which is illustrated in FIG. 3, the process retrieves the “CancelOrHold” parameter for this issue and determines whether the parameter is set to Cancel or set to Hold, as indicated at steps 132 and 134. For this issue, in this example, the “CancelOrHold” parameter is set to Hold, so, at step 140, the process sets the “Held” parameter to “Yes” on incoming Passive Liquidity Buy Order 8 and inserts it into the Liquidity process of the internal book according to price/time priority, as indicated at step 142. As such, Passive Liquidity Buy Order 8 cannot trade with an incoming sell order until the “Held” parameter is re-set, allowing it to trade.

Also, as a point of explanation, even though Passive Liquidity Buy Order 8 is priced less aggressively than Passive Liquidity Buy Order 4, the reason Passive Liquidity Buy Order 8 is held while Passive Liquidity Buy Order 4 is not held at this time is due to the fact that Passive Liquidity Buy Order 4 was already active in the internal book before Away Market A offered at $20.01. As an active order, Passive Liquidity Buy Order 4 would be able to trade with an incoming sell order if its price is capped at $20.01, the NBO, so that it would not trade through Away Market A's offer.
The NBBO is still 20.00 to 20.01 (1800×400)

The internal book looks like this:

| Bids | | Offers | |
|---|---|---|---|
| Order 4: | 600 @ 20.02 | MarketA: | 400 @ 20.01 |
| | Liquidity Process | | |
| Order 8: | 3000 @ 20.01, | Order 3: | 600 @ 20.04 |
| | Held = Yes [symbol] | | |
| | Liquidity Process | | |
| Order 1: | 500 @ 20.00 | | |
| | Show size = 500, | | |
| | Reserve size = 7500 | | |
| Order 2: | 1000 @ 20.00 | | |
| MarketA: | 300 @ 20.00 | | |

The public order book remains unchanged and still looks like this:

| Bids | Offers |
|---|---|
| Posting Market Center 1500 @ 20.00 | Posting Market Center |
| | 600 @ 20.04 |

### EXAMPLE 6

### Resting Passive Liquidity Order Cannot Match without Causing Trade Through; Status Changed to Held

In this example, the posting market center 20 receives the following order:
Order 9: Sell 1000 @ 20.02

Referring to FIG. 4, at step 152, the process retrieves the highest-priced buy order, which, in this example, is Passive Liquidity Buy Order 4 at $20.02. The process compares the price of the retrieved Buy Order ($20.02) to the price of incoming Sell Order 9 ($20.02) at step 154. As the prices are equal, the process proceeds to step 160, where it retrieves the NBB ($20.00). At step 162, the process compares the price of Passive Liquidity Buy Order 4 ($20.02) to the NBB ($20.00). As Order 4's price is higher, the process proceeds to step 163 where it determines that the Buy Order is a Passive Liquidity Order.

The process then, at steps 170 and 172, retrieves the NBO and compares the NBO ($20.01) to the price of Passive Liquidity Buy Order 4 ($20.02) to ensure the Passive Liquidity Order does not trade through the NBO. The Passive Liquidity Buy Order price in this example is higher than the NBO, so the process, at step 174, sets the “MatchPrice” equal to $20.01, the NBO price. The process then compares the incoming Sell Order price ($20.02) to the designated “MatchPrice” of $20.01 at step 178. Since the Sell Order price is higher then the designated MatchPrice, a match is not possible.

In Example 4, the process was able to improve the price of Passive Liquidity Buy Order 4 to allow it to match the incoming Sell Order without violating trade-through rules. Such price improvement cannot be granted in this example, however. Sell Order 9 is priced at $20.02 and, therefore, for Sell Order 9 to trade with the Passive Liquidity Buy Order 4, the match would have to happen at $20.02. Such a match is not permitted in this example because the NBO is $20.01, and the match cannot occur at a price above the NBO. The incoming Sell Order 9 also cannot be posted to the internal book while Passive Liquidity Buy Order 4 is active at $20.02 because it would lock the posting market center's own internal book, irrespective of the fact that this “lock”, if it was allowed to occur, would not be displayed to the public.

As a result, to prevent the internal book from locking, the process invokes the “Cancel Or Hold” routine, as indicated at steps 180 and 182. In accordance with FIG. 3, the process, in this example, changes the status of Passive Liquidity Buy Order 4 to “Held” at step 140 so that it cannot trade until the NBO moves away, just as Passive Liquidity Buy Order 8 from the prior example cannot trade until the NBO moves away. Once the status of Passive Liquidity Buy Order 4 is changed to “Held”, and the order is no longer able to trade with incoming sell orders, the process proceeds to step 166 of FIG. 4 to determine whether incoming Sell Order 9 still has shares available to trade. In this example, it does. It has 1000 shares still available to trade. The process, therefore, retrieves the next highest-priced non-held buy order (i.e. Order 1 in this example) at step 168 and returns to step 154. The process then compares the price of retrieved Buy Order 1 ($20.00) to the incoming Sell Order price ($20.02), determines they do not overlap, and posts Sell Order 9 to the internal book and to the public order book at step 156. The process is complete at step 158 as indicated.

The internal book looks like this at this point:

| Bids | | Offers | |
|---|---|---|---|
| Order 4: | 600 @ 20.02, | MarketA: | 400 @ 20.01 |
| | Held = Yes [symbol] | | |
| | Liquidity Process | | |
| Order 8: | 3000 @ 20.01, | Order 9: | 1000 @ 20.02 [symbol] |
| | Held = Yes | | |
| | Liquidity Process | | |
| Order 1: | 500 @ 20.00 | Order 3: | 600 @ 20.04 |
| | Show size = 500, | | |
| | Reserve size = 7500 | | |
| Order 2: | 1000 @ 20.00 | | |
| MarketA: | 300 @ 20.00 | | |

The public order book looks like this:

| Bids | Offers |
|---|---|
| Posting Market Center 1500 @ 20.00 | Posting Market Center |
| | 1000 @ 20.02 [symbol] |
| | Posting Market Center |
| | 600 @ 20.04 |

### EXAMPLE 7

### Away Market Center Moves its Offer Away, Unlocking and Uncrossing the “Held” Passive Liquidity Buy Orders

Away Market A changes its offer to 600 at $20.03, moving off the NBO.
The NBBO is now 20.00 to 20.02 (1800×1000). The posting market center 20 is alone at the NBO.

The internal book momentarily looks like this:

| Bids | | Offers | |
|---|---|---|---|
| Order 4: | 600 @ 20.02, | Order 9: | 1000 @ 20.02 |
| | Held = Yes [symbol] | | |
| | Liquidity Process | | |
| Order 8: | 3000 @ 20.01, | MarketA: | 600 @ 20.03 [symbol] |
| | Held = Yes | | |
| | Liquidity Process | | |
| Order 1: | 500 @ 20.00 | Order 3: | 600 @ 20.04 |
| | Show size = 500, | | |
| | Reserve size = 7500 | | |
| Order 2: | 1000 @ 20.00 | | |
| MarketA: | 300 @ 20.00 | | |

When the posting market center 20 detects the new NBO, it checks to see if any “Held” Passive Liquidity Buy Orders can be released. As step 202 (FIG. 5) indicates, for this example, the process retrieves the best (highest-priced) Passive Liquidity Buy Order with Held=Yes, which is Buy Order 4 in this example. In step 204, the process compares Passive Liquidity Buy Order 4's price ($20.02) to the NBO ($20.02). As the prices are equal in this example, at step 205, the process checks if the posting market center is at the NBO. Posted Sell Order 9 is at the NBO.

The process, therefore, retrieves the best (lowest-priced) Sell Order (i.e. Order 9 in this example) at step 208. At step 210, the process matches all 600 shares of “Held” Passive Liquidity Buy Order 4 with 600 shares of Sell Order 9 at $20.02, the Sell Order price. As a result, Passive Liquidity Buy Order 4 is completely filled and removed from the internal book.

Four hundred (400) shares of Sell Order 9 are still available to trade. The posting market center 20 is still at the NBO with Sell Order 9 at $20.02.

The internal book looks like this at the moment:

| Bids | | Offers | |
|---|---|---|---|
| Order 8: | 3000 @ 20.01, | Order 9: | 400 @ 20.02 [symbol] |
| | Held = Yes | | |
| | Liquidity Process | | |
| Order 1: | 500 @ 20.00 | MarketA: | 600 @ 20.03 |
| | Show size = 500, | | |
| | Reserve size = 7500 | | |
| Order 2: | 1000 @ 20.00 | Order 3: | 600 @ 20.04 |
| MarketA: | 300 @ 20.00 | | |

The public order book looks like this:

| Bids | Offers |
|---|---|
| Posting Market Center 1500 @ 20.00 | Posting Market Center |
| | 400 @ 20.02 [symbol] |
| | Posting Market Center |
| | 600 @ 20.04 |

At step 212, the process checks whether Passive Liquidity Buy Order 4 has any shares remaining. As the order has been completely filled, the process continues to step 220, where it checks whether there are any additional Passive Liquidity Buy Orders with the status of Held. The process retrieves the next highest-priced Passive Liquidity Buy Order with a “Held” designation (i.e. Order 8) at step 222. The process returns to step 204, where it checks if “Held” Passive Liquidity Buy Order 8's price ($20.01) is lower than the NBO ($20.02). As Order 8's price is lower, the process continues to step 206, where it changes the status of Passive Liquidity Buy Order 8 from “Held” to “Not Held”. Buy Order 8 is now eligible to trade with incoming sell orders.

In step 220, the process checks whether there are any additional Passive Liquidity Buy Orders with the status of “Held”. As it finds no other “Held” orders, the process is complete, as illustrated at step 224.

The internal book looks like this:

| Bids | | Offers | |
|---|---|---|---|
| Order 8: | 3000 @ 20.01 [symbol] | Order 9: | 400 @ 20.02 |
| | Liquidity Process | | |
| Order 1: | 500 @ 20.00 | MarketA: | 600 @ 20.03 |
| | Show size = 500, | | |
| | Reserve size = 7500 | | |
| Order 2: | 1000 @ 20.00 | Order 3: | 600 @ 20.04 |
| MarketA: | 300 @ 20.00 | | |

The public order book still looks like this:

| Bids | Offers |
|---|---|
| Posting Market Center 1500 @ 20.00 | Posting Market Center |
| | 400 @ 20.02 |
| | Posting Market Center |
| | 600 @ 20.04 |

### EXAMPLE 8

### Changed Limit Buy Order Steps Ahead of Passive Liquidity Buy Order in the Rankings

In this example, the posting market center 20 receives a request to change the price of posted Buy Order 1 from $20.00 to $20.01:
Cancel/Replace Order 1: Buy 8000 @ 20.01, Show size=500, Reserve size=7500

In response, the posting market center 20 changes the price of Buy Order 1. Because Buy Order 1's shares reside in the Display Process and the Reserve Process, Buy Order 1 now has higher priority than Passive Liquidity Buy Order 8, which resides in the Liquidity Process. The preference for displayed interest over nondisplayed interest at the same price trumps time priority.
The NBBO is now 20.01 to 20.02 (500×400).

The internal book now looks like this:

| Bids | | Offers | |
|---|---|---|---|
| Order 1: | 500 @ 20.01 [symbol] | Order 9: | 400 @ 20.02 |
| | Show size = 500, | | |
| | Reserve size = 7500 | | |
| Order 8: | 3000 @ 20.01 | MarketA: | 600 @ 20.03 |
| | Liquidity Process | | |
| Order 2: | 1000 @ 20.00 | Order 3: | 600 @ 20.04 |
| MarketA: | 300 @ 20.00 | | |

The public order book looks like this:

| Bids | Offers |
|---|---|
| Posting Market Center 500 @ 20.01 [symbol] | Posting Market Center |
| | 400 @ 20.02 |
| Posting Market Center 1000 @ 20.00 [symbol] | Posting Market Center |
| | 600 @ 20.04 |

### EXAMPLE 9

### Marketable Sell Order is Received; Displayed Buy Order has Priority Over Passive Liquidity Order at the Same Price

In this example, the posting market center 20 receives the following order:
Order 20: Sell 2000 @ 20.01

Referring to FIG. 4, the process retrieves the highest-priced Buy Order (i.e. Order 1) and compares it to the incoming Sell Order, as indicated at steps 152 and 154. The prices are equal, so the process retrieves the NBB ($20.01) at step 160. At step 162, the process compares the price of Buy Order 1 ($20.01) to the NBB ($20.01). As the prices are equal, the process determines whether the retrieved Buy Order is a Passive Liquidity Order, as indicated at step 163. It determines that Buy Order 1 is not a Passive Liquidity Order, so the process trades Buy Order 1 according to the normal trading rules governing the order types, as indicated at step 164. As such, it matches 500 shares of incoming Sell Order 20 with posted Buy Order 1 in the Display Process, and matches the remaining 1500 shares of incoming Sell Order 20 with posted Buy Order 1 in the Reserve Process. The process checks to see if incoming Sell Order 20 still has shares available to trade at step 166. In this example, it finds none and determines that the order is complete at step 186.

The process goes on to replenish the Show size (500 shares) of posted Buy Order 1 in the Display Process level, according to the normal processing rules for Reserve order types. Buy Order 1 still has 5500 shares left in Reserve. Passive Liquidity Buy Order 8 did not trade at all because Passive Liquidity Orders cannot trade until all shares at the same price point that reside in the Display Process and the Reserve Process are exhausted.

The internal book looks like this:

| Bids | | Offers | |
|---|---|---|---|
| Order 1: | 500 @ 20.01 [symbol] | Order 9: | 400 @ 20.02 |
| | Show size = 500, | | |
| | Reserve size = 5500 | | |
| Order 8: | 3000 @ 20.01 | MarketA: | 600 @ 20.03 |
| | Liquidity Process | | |
| Order 2: | 1000 @ 20.00 | Order 3: | 600 @ 20.04 |
| MarketA: | 300 @ 20.00 | | |

The public order book remains unchanged and still looks like this:

| Bids | Offers |
|---|---|
| Posting Market Center 500 @ 20.01 | Posting Market Center |
| | 400 @ 20.02 |
| Posting Market Center 1000 @ 20.00 | Posting Market Center |
| | 600 @ 20.04 |

### EXAMPLE 10

### Nonmarketable Passive Liquidity Sell Order is Received

In this example, the posting market center 20 receives the following order:
Order 21: Sell 5000 @ 20.02, Passive Liquidity

The order matching engine 21 implements the process illustrated in FIG. 6, which is similar to the process executed when a Passive Liquidity Buy Order was received. First, the process retrieves the NBBO ($20.01 to $20.02) and checks to see whether it is locked or crossed, as indicated at steps 302 and 304. As the NBBO is not locked or crossed, at steps 308 and 310, the process retrieves the best (highest-priced) Buy Order (i.e. Order 1) and compares the Buy Order price ($20.01) to the NBB ($20.01).

Since, in this example, the Buy Order price is the same as the NBB, the Passive Liquidity Sell Order can trade with the Buy Order if their prices overlap. At step 312, the process compares the price of incoming Passive Liquidity Sell Order 21 ($20.02) to the price of posted Buy Order 1 ($20.01) and determines that the Sell Order price is higher. As such, incoming Passive Liquidity Sell Order 21 is not marketable and does not lock the NBB. The process, accordingly, inserts the order in price/time priority in the Liquidity Process of its internal book, as indicated at step 322, and processing is complete at step 324.

The internal book looks like this:

| Bids | | Offers | |
|---|---|---|---|
| Order 1: | 500 @ 20.01 | Order 9: | 400 @ 20.02 |
| | Show size = 500, | | |
| | Reserve size = 5500 | | |
| Order 8: | 3000 @ 20.01 | Order 21: | 5000 @ 20.02 [symbol] |
| | Liquidity Process | | Liquidity Process |
| Order 2: | 1000 @ 20.00 | MarketA: | 600 @ 20.03 |
| MarketA: | 300 @ 20.00 | Order 3: | 600 @ 20.04 |

The public order book remains unchanged and still looks like this:

| Bids | Offers |
|---|---|
| Posting Market Center 500 @ 20.01 | Posting Market Center |
| | 400 @ 20.02 |
| Posting Market Center 1000 @ 20.00 | Posting Market Center |
| | 600 @ 20.04 |

### EXAMPLE 11

### Nonmarketable Reserve Sell Order is Posted to the Order Book

In this example, the posting market center 20 receives the following Reserve Order:
Order 22: Sell 2000 @ 20.02, Show size=200, Reserve size=1800

Referring to FIG. 4, at step 152, the process retrieves the best-priced Buy Order, Buy Order 1. At step 154, the process compares the price of incoming Sell Order 22 ($20.02) to the price of posted Buy Order 1 ($20.01). As the prices do not overlap, the process continues to step 156, where Order 22 is processed according to the normal rules for processing Reserve Orders. As Order 22 is not marketable, the process posts the order to the internal book. Two hundred (200) shares of Order 22 are inserted in the Display Process and 1800 shares of Order 22 are inserted into the Reserve Process. As a result, Reserve Order 22 has a higher priority than Passive Liquidity Order 21, as both orders have the same price, but the Display Process and the Reserve Process trump the Liquidity Process.

The internal book looks like this:

| Bids | | Offers | |
|---|---|---|---|
| Order 1: | 500 @ 20.01 | Order 9: | 400 @ 20.02 |
| | Show size = 500, | | |
| | Reserve size = 5500 | | |
| Order 8: | 3000 @ 20.01 | Order 22: | 200 @ 20.02 [symbol] |
| | Liquidity Process | | Show size = 200, |
| | | | Reserve size = 1800 |
| Order 2: | 1000 @ 20.00 | Order 21: | 5000 @ 20.02 |
| | | | Liquidity Process |
| MarketA: | 300 @ 20.00 | MarketA: | 600 @ 20.03 |
| | | Order 3: | 600 @ 20.04 |

The public order book looks like this:

| Bids | Offers |
|---|---|
| Posting Market Center 500 @ 20.01 | Posting Market Center |
| | 600 @ 20.02 [symbol] |
| Posting Market Center 1000 @ 20.00 | Posting Market Center |
| | 600 @ 20.04 |

### EXAMPLE 12

### Market Buy Order is Received

In this example, the posting market center 20 receives the following order:
Order 23: Buy 3000 @ Market

At step 352 of FIG. 7, the process retrieves the best Sell Order, which is posted limit Sell Order 9 in this example. At step 354, the process compares the price of incoming limit Buy Order 23 (Market) to the price of retrieved Sell Order 9 ($20.02). As Market orders are marketable by definition, the process determines whether Sell Order 9 is eligible for matching by retrieving the NBO ($20.02) at step 360 and comparing it to the price of Sell Order 9 ($20.02) at step 362. They are equal in this example. Therefore, the process proceeds to step 363 where it checks whether Sell Order 9 is a Passive Liquidity Order or not. As Sell Order 9 is a regular limit-priced order and not a Passive Liquidity Order, the process proceeds to step 364, where it matches 400 shares of incoming Buy Order 23 with 400 shares of posted limit Sell Order 9 at the price of $20.02 according to the regular rules that govern trading of the order types, completely filling posted Sell Order 9 and removing it from the books. At step 366, the process determines that 2600 shares of incoming Buy Order 23 are still available to trade, and returns to step 368, where it retrieves the next best sell order, Reserve Sell Order 22.

As Reserve Sell Order 22 is the same price as limit Sell Order 9, the process repeats the steps described above for determining that incoming Buy Order 23 can match with Reserve Sell Order 22. At step 364, the process then matches incoming Buy Order 23 with 200 shares (the Show size) of posted Reserve Sell Order 22 in the Display Process and with 1800 shares (the Reserve size) of posted Reserve Sell Order 22 in the Reserve Process according to the rules that govern the order types, completely filling Reserve Sell Order 22 and removing it from the books. At step 366, the process determines that six hundred (600) shares of incoming Buy Order 23 are left available to trade, and continues to step 368, where it retrieves the next-best Sell Order, which is Passive Liquidity Sell Order 21.

At this point, all of the Display shares and Reserve shares priced at $20.02 have been exhausted. The process continues on, in this example, to match the remaining 600 shares of incoming Buy Order 23 with resting Passive Liquidity Sell Order 21. Specifically, the process determines that incoming Buy Order 23 is marketable against Passive Liquidity Sell Order 21, determines that the Sell Order price is at the NBO, and determines that Sell Order 21 is indeed a Passive Liquidity Sell Order, as indicated in FIG. 7 at steps 354, 360, 362 and 363. The process retrieves the NBB and compares the price of Passive Liquidity Sell Order 21 ($20.02) to the NBB ($20.01), at steps 370 and 372. In this example, the Passive Liquidity Sell Order price is higher than the NBB, so the process sets the “MatchPrice” parameter equal to the specified limit price of Passive Liquidity Sell Order 21 ($20.02) at step 376. The process matches the remaining 600 shares of incoming Buy Order 23 with Passive Liquidity Sell Order 21 at the “MatchPrice” of $20.02, as indicated at step 384. The process then determines that incoming Buy Order 23 has no shares remaining to trade and that processing is complete, as indicated at steps 366 and 386. Passive Liquidity Sell Order 21 has 4400 shares remaining to trade.
The NBBO is 20.01 to 20.03 (500×600)

The internal book looks like this:

| Bids | | Offers | |
|---|---|---|---|
| Order 1: | 500 @ 20.01 | Order 21: | 4400 @ 20.02 [symbol] |
| | Show size = 500, | | Liquidity Process |
| | Reserve size = 5500 | | |
| Order 8: | 3000 @ 20.01 | MarketA: | 600 @ 20.03 |
| | Liquidity Process | | |
| Order 2: | 1000 @ 20.00 | Order 3: | 600 @ 20.04 |
| MarketA: | 300 @ 20.00 | | |

The public order book looks like this:

| Bids | Offers |
|---|---|
| Posting Market Center 500 @ 20.01 | Posting Market Center |
| | 600 @ 20.04 [symbol] |
| Posting Market Center 1000 @ 20.00 | |

### EXAMPLE 13

### Passive Liquidity Buy Order is Ranked and Executed on an Options Marketplace

The examples that follow immediately illustrate one implementation of how Passive Liquidity Orders trade on an options marketplace. In these examples, the posting market center 20 has appointed Market Makers 31 in some issues. When an appointed Market Maker is the Lead Market Maker in the issue, then that Market Maker is guaranteed participation with incoming orders in accordance with the business rules of the posting market center. By way of example, some of those business rules are implemented in the Order Execution Process referred to as the Lead Market Maker Guarantee Process in this document.

It should be understood that the Market Maker Guarantee Process described below is subject to change and serves only to illustrate the matching priority of Market Maker quotes 33 in relation to resting Passive Liquidity Orders 29 stored on the posting market center 20, and that a broader discussion of Market Maker rules, responsibilities, and entitlements is beyond the scope of this document. For the purposes of this example, the issue has a Lead Market Maker, and if the Lead Market Maker is quoting at the NBBO at the time an incoming marketable order is received, the Lead Market Maker is guaranteed participation with the incoming order. In this example, participation is guaranteed for up to 40% of the remaining quantity of the incoming order, after customer orders with price/time priority ahead of the Lead Market Maker's quote have been satisfied first. As the business rules for the Lead Market Maker Guarantee Process may be implemented differently, it should be noted that the purpose of these examples is not to illustrate Market Maker Guarantees, it is to illustrate the ranking of Market Maker quotes compared to Passive Liquidity Orders within the order matching engine 21. The invention is in no way limited to the embodiments used below for illustration purposes.

In this example, the following orders are posted to the internal book of the posting market center 20 at the start:
Order 31: Buy 80 @ 2.00
Order 32: Buy 50 @ 2.00
Order 33: Sell 60 @ 2.15

Away Market Center A has disseminated a bid to buy 30 at $2.00 and an offer to sell 40 at $2.10. In the examples that follow, Away Market Center A's quote is shown in the same table as Market Maker LMM's quote 33 for illustration purposes, although away market quotes may actually be stored in a different table 25. This issue has a Lead Market Maker (“LMM”) whose quotes were received by the posting market center 20 before the orders (i.e. Market Maker LMM's bid has time priority over Order 31 and Order 32 in this example).
The NBBO is 2.00 to 2.10 (230×90).

The combined Quote Book looks like this:

| Bids | Offers |
|---|---|
| LMM Bid: 70 @ 2.00 | LMM Offer: 50 @ 2.10 |
| MarketA: 30 @ 2.00 | MarketA: 40 @ 2.10 |

The internal order book looks like this:

| Bids | Offers |
|---|---|
| Order 31: 80 @ 2.00 | Order 33: 60 @ 2.15 |
| Order 32: 50 @ 2.00 | |

The public order book, which displays the aggregated quantity of posting market center Market Maker quotes and disclosed orders at each price level, looks like this:

| Bids | Offers |
|---|---|
| Posting Market Center 200 @ 2.00 | Posting Market Center |
| | 50 @ 2.10 |
| | Posting Market Center |
| | 60 @ 2.15 |

In this example, the posting market center 20 receives the following order:
Order 34: Buy 20 @ 2.05, Passive Liquidity

Referring to FIG. 2, when the posting market center 20 receives this incoming Passive Liquidity Buy Order, the order matching engine process 21 is activated. The process, as described above, retrieves the NBBO ($2.00 to $2.10) at step 102 and checks to see if it is locked or crossed at step 104. As the NBBO is not locked or crossed, the process checks to see whether the received Buy Order is marketable. In this regard, at step 108, the process retrieves the lowest-priced Sell Order. The order matching engine 21 determines that the Market Maker offer at $2.10 is its best “order” (it would dynamically generate an order on behalf of this quote to trade it) and, at step 110, compares the retrieved offer price ($2.10) to the NBO ($2.10). The retrieved offer price, in this example, is equal to the NBO. The process, therefore, continues to step 112, where it compares the price of incoming Passive Liquidity Buy Order 34 ($2.05) to the offer price ($2.10). As the Buy Order price is lower, the order is not marketable against the Market Maker offer.

The process proceeds to step 122 where it inserts Passive Liquidity Buy Order 34 in the internal book in the Liquidity Process level, a “hidden” level of the Working Process, as indicated at step 122. As Passive Liquidity Orders are not displayed, the order is not published to the posting market center order book, and the process is complete, as indicated at step 124.
The NBBO is still 2.00 to 2.10 (230×90).

The combined Quote Book still looks like this:

| Bids | Offers |
|---|---|
| LMM Bid: 70 @ 2.00 | LMM Offer: 50 @ 2.10 |
| MarketA: 30 @ 2.00 | MarketA: 40 @ 2.10 |

The internal order book now looks like this:

| Bids | Offers |
|---|---|
| Order 34: 20 @ 2.05 [symbol] | Order 33: 60 @ 2.15 |
| Liquidity Process | |
| Order 31: 80 @ 2.00 | |
| Order 32: 50 @ 2.00 | |

The public order book still looks like this:

| Bids | Offers |
|---|---|
| Posting Market Center 200 @ 2.00 | Posting Market Center |
| | 50 @ 2.10 |
| | Posting Market Center |
| | 60 @ 2.15 |

### EXAMPLE 14

### Passive Liquidity Buy Order Trades with Incoming Sell Order

In this example, the posting market center 20 receives the following limit order:
Order 35: Sell 10 @ 2.00

When a Lead Market Maker is quoting at the NBBO in an assigned issue when a marketable non-directed incoming order is received, the Market Maker is generally entitled to preferential trading in the Lead Market Maker Guarantee Process. In this example, Market Maker LMM's bid ($2.00) is at the NBB ($2.00), so the Lead Market Maker Guarantee Process is automatically invoked. However, before any part of a Lead Market Maker's quote can trade, any superior orders must be satisfied first. In this example, the Lead Market Maker's bid has time priority over all the displayed Buy Orders posted in the internal order book (i.e. Order 31 and Order 32). However, Passive Liquidity Buy Order 34 has a superior price ($2.05) to the LMM Bid ($2.00), so it must execute first. Therefore, referring to FIG. 4, the process, at step 152, retrieves the highest-priced buy order, which is Passive Liquidity Buy Order 34 at $2.05. The process compares this order to the price of incoming Sell Order 35 ($2.00), as indicated at step 154. As the prices overlap, the process proceeds to step 160, where it retrieves the NBB ($2.00). At step 162, the process compares the price of Passive Liquidity Buy Order 34 ($2.05) to the NBB. As Order 34's price is higher, the process determines whether the Buy Order is a Passive Liquidity Order at step 163. It is.

As Passive Liquidity Buy Orders cannot trade through the NBO, the process retrieves the NBO at step 170 and compares the price of Passive Liquidity Buy Order 34 ($2.05) to the NBO ($2.10), as indicated at step 172. The Passive Liquidity Buy Order price is less than the NBO, so the process sets the “MatchPrice” equal to $2.05, the specified limit price of Passive Liquidity Buy Order 34, at step 176.

At step 184, the process matches incoming Sell Order 35 with Passive Liquidity Buy Order 34 at $2.05. The match is priced at $2.05 because, again, Passive Liquidity Orders do not receive price improvement unless it is required to prevent a trade-through of an away market.

The process, at steps 166 and 186, determines that incoming Sell Order 35 has no remaining shares to trade, and its processing is complete. The remaining 10 shares of Passive Liquidity Buy Order 34 continue to reside in the Liquidity process, as they had done previously.
The NBBO is still 2.00 to 2.10 (230×90).

The combined Quote Book still looks like this:

| Bids | Offers |
|---|---|
| LMM Bid: 70 @ 2.00 | LMM Offer: 50 @ 2.10 |
| MarketA: 30 @ 2.00 | MarketA: 40 @ 2.10 |

The internal order book now looks like this:

| Bids | Offers |
|---|---|
| Order 34: 10 @ 2.05 [symbol] | Order 33: 60 @ 2.15 |
| Liquidity Process | |
| Order 31: 80 @ 2.00 | |
| Order 32: 50 @ 2.00 | |

The public order book still looks like this:

| Bids | Offers |
|---|---|
| Posting Market Center 200 @ 2.00 | Posting Market Center |
| | 50 @ 2.10 |
| | Posting Market Center |
| | 60 @ 2.15 |

### EXAMPLE 15

### Incoming Passive Liquidity Sell Order matches Resting Passive Liquidity Buy Order

In this example, the posting market center 20 receives the following order:
Order 36: Sell 10 @ 2.00, Passive Liquidity

As in Example 14, Market Maker LMM's bid ($2.00) is at the NBB ($2.00), so the Lead Market Maker Guarantee Process is automatically invoked. However, before any part of a Lead Market Maker's quote can trade, any superior orders must be satisfied first. As Passive Liquidity Buy Order 34 has a superior price ($2.05) to Market Maker LMM's bid ($2.00), it must execute first.

Referring to FIG. 6, when the posting market center 20 receives this incoming Passive Liquidity Sell Order, the order matching engine process 21 is activated. The process, as described above, retrieves the NBBO ($2.00 to $2.10) at step 302 and checks to see if the market is locked or crossed at step 304. As the NBBO is not locked or crossed, the process checks to see whether the received Sell Order is marketable. In this regard, at steps 308 and 310, the process retrieves the highest-priced Buy Order. The process determines that Passive Liquidity Buy Order 34 is the best-priced Buy Order.

At step 310, the process compares the price of Passive Liquidity Buy Order 34 ($2.05) to the NBB ($2.00). In this example, Order 34's price is higher than the NBB, so the process continues to step 312, where it compares the price of incoming Passive Liquidity Sell Order 36 ($2.00) to the price of resting Passive Liquidity Buy Order 34 ($2.05). As the prices overlap, the orders can match each other. The process matches incoming Passive Liquidity Sell Order 36 with resting Passive Liquidity Buy Order 34 at the price of $2.05, the Buy Order's price. Passive Liquidity Buy Order 34 is completely depleted and removed from the internal book. At step 316, the process checks to see if incoming Passive Liquidity Sell Order 36 has any contracts remaining, and determining that it does not, the process terminates in step 324.

The combined Quote Book still looks like this:

| Bids | Offers |
|---|---|
| LMM Bid: 70 @ 2.00 | LMM Offer: 50 @ 2.10 |
| MarketA: 30 @ 2.00 | MarketA: 40 @ 2.10 |

The internal order book now looks like this:

| Bids | Offers |
|---|---|
| Order 31: 80 @ 2.00 | Order 33: 60 @ 2.15 |
| Order 32: 50 @ 2.00 | |

The public order book still looks like this:

| Bids | Offers |
|---|---|
| Posting Market Center 200 @ 2.00 | Posting Market Center |
| | 50 @ 2.10 |
| | Posting Market Center |
| | 60 @ 2.15 |

While the invention has been discussed in terms of certain embodiments, it should be appreciated that the invention is not so limited. The embodiments are explained herein by way of example, and there are numerous modifications, variations and other embodiments that may be employed that would still be within the scope of the present invention.

What is claimed is:

1. A method for providing liquidity to a market center, comprising:
providing a posting market center with displayed and nondisplayed orders;
receiving and maintaining a passive liquidity order having a specified price on the posting market center, wherein the passive liquidity order is not displayed to the marketplace; and
executing the displayed and nondisplayed orders on the posting market center against incoming orders, wherein incoming orders match with displayed orders prior to matching passive liquidity orders at the same price level.

2. The method of claim 1, wherein the passive liquidity order is a buy order.

3. The method of claim 1, wherein the passive liquidity order is a sell order.

4. A method for providing liquidity to a market center, comprising:
providing a posting market center with displayed and nondisplayed orders on an order book;
receiving a passive liquidity order having a price on the posting market center;
determining whether the national best bid and offer is locked or crossed when the order is received;
wherein if the national best bid and offer is locked or crossed, determining whether the received passive liquidity order is to be canceled or held.

5. The method of claim 4, wherein if the passive liquidity order is to be canceled, canceling the order.

6. The method of claim 4, wherein the posting market center has a set of ranking rules for a plurality of order types and wherein if the passive liquidity order is to be held, setting the status of the received passive liquidity order to a held condition until the passive liquidity order can be released as an active order; and
storing the passive liquidity order in a held condition on the posting market center according to the ranking rules for the passive liquidity order type.

7. A method for providing liquidity to a market center, comprising:
providing a posting market center with displayed and nondisplayed orders on an order book;
receiving a passive liquidity order having a price on the posting market center;
retrieving the best priced displayed order on the side of the order book contra to the passive liquidity order;
determining whether the contra side order can be matched with the passive liquidity order without trading through the national best bid and offer; and
wherein if the contra side order cannot be matched with the passive liquidity order without trading through the national best bid and offer, determining whether the price of the passive liquidity order locks or crosses the national best bid and offer.

8. The method of claim 7, wherein if the price of the passive liquidity order does lock or cross the national best bid and offer, determining whether the received passive liquidity order is to be canceled or held.

9. The method of claim 8, wherein if the passive liquidity order is to be canceled, canceling the order.

10. The method of claim 8, wherein the posting market center has a set of ranking rules for a plurality of order types and wherein if the passive liquidity order is to be held, setting the status of the received passive liquidity order to a held condition until the passive liquidity order can be released as an active order; and
storing the passive liquidity order in a held condition on the posting market center according to the ranking rules for the passive liquidity order type.

11. The method of claim 7, wherein if the price of the passive liquidity order does not lock or cross the national best bid and offer, inserting the passive liquidity order in the posting market center order book as a nondisplayed order.

12. A method for providing liquidity to a market center, comprising:
providing a posting market center with displayed and nondisplayed orders on an order book;
receiving a passive liquidity order having a price on the posting market center;
retrieving the best priced displayed order on the side of the order book contra to the passive liquidity order;
determining whether the contra side order can be matched with the passive liquidity order without trading through the national best bid and offer;
wherein if the contra side order can be matched without trading through the national best bid and offer, determining whether the passive liquidity order overlaps with the contra side order.

13. The method of claim 12, wherein if the passive liquidity order does not overlap with the contra side order, inserting the passive liquidity order in the posting market center order book as a nondisplayed order.

14. The method of claim 12, wherein if the passive liquidity order does overlap with or is equal to the contra side order, matching the passive liquidity order with the contra side order.

15. The method of claim 12, wherein after receiving the passive liquidity order on the posting market center, determining whether the national best bid and offer is locked or crossed.

16. The method of claim 12, wherein the passive liquidity order is a buy order and the contra-side order is a sell order.

17. The method of claim 16, wherein the posting market center retrieves the national best offer price and the passive liquidity buy order is canceled or held when a determination is made that the passive liquidity buy order price is greater than or equal to the national best offer price.

18. The method of claim 17, further comprising:
determining an updated national best offer price, wherein the updated national best offer price has moved higher than the passive liquidity buy order price and the buy order is no longer held.

19. The method of claim 12, wherein the passive liquidity order is a sell order and the contra-side order is a buy order.

20. The method of claim 19, wherein the posting market center retrieves the national best bid price and the passive liquidity sell order is canceled or held when a determination is made that the passive liquidity sell order price is lower than or equal to the national best bid price.

21. The method of claim 20, further comprising:
determining an updated national best bid price, wherein the updated national best bid price has moved lower than the passive liquidity sell order price and the sell order is no longer held.

22. A method for providing liquidity to a market center, comprising:
providing a posting market center with displayed and nondisplayed passive liquidity orders on an order book;
receiving an order on the posting market center order book;
retrieving the best priced order on the side of the order book contra to the incoming order;
determining whether the order retrieved from the order book is a passive liquidity order; wherein when the retrieved order is a passive liquidity order, setting the price of the passive liquidity order such that passive liquidity order does not trade through the national best bid and offer;
determining whether the price of the incoming order overlaps with or is equal to the price set for the passive liquidity order; and
wherein if the price of the incoming order overlaps with or is equal to the price set for the passive liquidity order, matching the incoming order with the passive liquidity order.

23. The method of claim 22, wherein the retrieved passive liquidity order is a buy order and the incoming order is a sell order.

24. The method of claim 23, wherein setting the price of the passive liquidity buy order is accomplished by capping the price of the passive liquidity buy order at the national best offer price to prevent a trade through violation.

25. The method of claim 24, wherein when the capped price of the retrieved passive liquidity buy order does not overlap with nor is equal to the price of the incoming sell order, the retrieved passive liquidity buy order is canceled or held.

26. The method of claim 22, wherein the retrieved passive liquidity order is a sell order and the incoming order is a buy order.

27. The method of claim 26, wherein setting the price of the passive liquidity sell order is accomplished by capping the price of the passive liquidity sell order at the national best bid price to prevent a trade through violation.

28. The method of claim 27, wherein when the capped price of the retrieved passive liquidity sell order does not overlap with nor is equal to the price of the incoming buy order, the retrieved passive liquidity sell order is canceled or held.

29. The method of claim 22, wherein when the price of the passive liquidity order is set, the passive liquidity order does not receive price improvement.

30. The method of claim 22, wherein when the price of the passive liquidity order is set, the passive liquidity order receives price improvement if it cannot execute at its specified limit price because that price would trade through the national best bid or offer, and therefore the passive liquidity order must execute at an improved price.

31. A method for providing liquidity to a market center, comprising:
providing a market center with displayed orders, partially displayed orders, and nondisplayed orders and published market maker quotes;
receiving and maintaining a passive liquidity order having a price on the posting market center, wherein the passive liquidity order is not displayed to the marketplace; and
executing against incoming orders, wherein incoming orders match with displayed orders, market maker quotes and partially displayed orders prior to matching with passive liquidity orders at the same price level.

32. A method for providing liquidity to a market center, comprising:
providing a market center with an order book having displayed orders, partially displayed orders, nondisplayed orders and published market maker quotes;
receiving and maintaining a passive liquidity order having a specified price and size on the posting market center, wherein the passive liquidity order is not displayed to the marketplace and wherein the passive liquidity order has a superior price to the displayed orders, market maker quotes and partially displayed orders; and
executing against incoming orders, wherein the passive liquidity order having a superior price that grants it price priority ahead of the displayed orders, market maker quotes and partially displayed orders, the passive liquidity order executes prior to the displayed orders, market maker quotes and partially displayed orders.

33. A posting market center, comprising:
an order book with displayed and nondisplayed orders;
an interface for receiving orders, including passive liquidity orders;
a posting market center memory for storing code for analyzing and processing passive liquidity orders;
a processor for interacting with the interface and executing the code for analyzing and processing passive liquidity orders stored in the memory when the interface receives a passive liquidity order, wherein the code, when executed:
retrieves the best priced displayed order on the side of the order book contra to the passive liquidity order;
determines whether matching the passive liquidity order with the retrieved contra-side order will trade through the national best bid and offer; and
determines whether the price of the passive liquidity order overlaps with or is equal to the price of the retrieved contra-side order, wherein the passive liquidity order is matched with the contra-side order when the determination is made that matching the passive liquidity order with the contra-side order will not trade through the national best bid and offer and that the price of the passive liquidity order overlaps with or is equal to the price of the retrieved contra-side order.

34. The posting market center of claim 33, further comprising an interface for maintaining and publishing market maker quotes and for automatically generating an order on behalf of such a quote when such quote is determined to be marketable;
